(19) United States
(12) Patent Application Publication
(10) Pub. No.: US 2022/0183271 A1
(43) Pub. Date: Jun. 16, 2022

(54) Methods and Systems for Protective Supplementation During Temperature Depression

(71) Applicant: MEMBRANE PROTECTIVE TECHNOLOGIES, INC., Fort Collins, CO (US)

(72) Inventors: Amy Scharf, Fort Collins, CO (US); Lisa A. Herickhoff, Fort Collins, CO (US); James Herickhoff, Fort Collins, CO (US); Myles Shepherd, Nunn, CO (US)

(21) Appl. No.: 17/438,830

(22) PCT Filed: Mar. 13, 2020
(86) PCT No.: PCT/US2020/022736

§ 371 Date: Sep. 13, 2021

Related U.S. Application Data
(60) Provisional application No. 62/818,002, filed on Mar. 13, 2019.

(51) Int. Cl. A01N 1/02

(52) U.S. Cl. CPC A01N 1/0221; A01N 1/0226

(57) ABSTRACT

Embodiments of the present invention provide ways to reduce detrimental impacts to in vitro and in vivo specimens (8) from temperature depression with certain medium (9) and may include providing a protective layer (7) around a droplet (12) which may contain a medium and a specimen before subjecting to temperature depression. Other embodiments may provide treatment to a recipient environment (41) before implantation of a specimen (40) which has been subjected to a temperature depression.

### PRIORITY CLAIM

This application is a PCT patent application claiming priority to and the benefit of U.S. Provisional Application No. 62/818,002 filed Mar. 13, 2019, hereby incorporated by reference herein in its entirety.

### GOVERNMENT LICENSE RIGHTS

This application relates to work performed under USDA-NIFA SBIR Phase I grant #2019-33610-29786. The U.S. government may have certain rights in this inventive technology, including “march-in” rights, as provided for by the terms of USDA-NIFA SBIR Phase I grant #2019-33610-29786.

### TECHNICAL FIELD

The present invention relates to systems and methods to positively affect temperature depression perhaps including cooling, slow freeze, freezing, and even vitrification of specimens such as cells, tissues, genetic materials and the like. Methods may include mitigation of damages from detrimental compounds associated with temperature depression to specimens. Damages may include but are not limited to: DNA breakage and impairment, loss of membrane integrity, organellular rearrangement and/or disfunction, and perhaps even contamination by foreign compounds, or the like. Embodiments of the present invention may also provide methods and systems for preparation of a recipient environment.

### BACKGROUND

It may be understood that depression of temperature such as cooling or cryopreservation may generally be a good method for long and/or even short-term preservation of specimens such as gametes, germ cells, unique cell lines, stem cells, bacterial, fungal, algal cells and the like. Unfortunately, temperature depression below the in vivo standard (e.g., ˜37° C.) can also negatively affect the integrity of the cell perhaps by causing changes to the lipid bilayer and even the proteins within the lipid bilayer. Damage may cause breaks in the DNA and organelles as well. Similarly, aggregated cellular damage as described can result in damage to tissues or organs in vitro. Such changes can be fatal to the cell, the aggregation of cell, tissue or organ, or the potential for future use of said materials.

Cryopreserved cells may be stored at about −20° C., −40° C., −80° C. or even about −196° C. (liquid nitrogen storage). Recall, while cooled or frozen, storage at higher temperatures (commonly about 17° C. to perhaps −20° C.) may slow the metabolism of the cells, some metabolic processes may still be occurring which may generate reactive compounds including oxygenated-, nitrogenated-, sulfated-reactive species, and other bi-products. These may be released into the cell or storage medium and may ultimately damage the integrity of the cell or tissue. This might be limited when cells are stored at about −196° C., where cellular metabolism may be all but stopped until such a time as the cryopreserved materials are warmed. Moreover, these temperature depressed cells may have cooling/freezing/warming induced damage which occurred during passage through cellularly unstable temperature zones.

A goal of cryopreservation may include the saving of materials for future use. However, damage affects said use. As but one non-limiting example, in vivo derived embryos have higher pregnancy rates than in vitro derived embryos which demonstrates the potential and need for development of in vitro media systems (containing multiple medium) or individual medium, to create higher quality embryos after in vitro production. While the temperature depression processes may include some proposed protection of cells from damage, these protective measures may also be damaging. For example, cryoprotectants may act by increasing the solute concentration inside the cell perhaps to help the cell withstand freezing and vitrification. Biologically relevant cryoprotectants may penetrate cells and may be only of limited toxicity to the cells or tissue or perhaps should dehydrate the liquid out of the cell to decrease the ice crystal formation within the cell. Unfortunately, cryopreservation including cryoprotectants can be stressful on cells and tissues, affecting function and integrity, and ice crystals may still damage membranes. Cryoprotectants may also be toxic to the cell functionality; the effects of toxicity may include cytoskeletal reorganization, suppression of normal metabolism, membrane composition shifts, 3-dimensional reorganization of organelles, increased production of reactive compounds, or the like. Upon return from a temperature depressed state, thawing, if the cell has survived the effects of the toxicity, the plasma membrane, DNA and other organelles may be damaged from the passage back through the unstable zone. For example, perhaps the mitochondria may be displaced to a different location within the cell such that the cell may no longer be functional or may have limited competence, or they may undergo fission and/or fusion. It is well understood that fresh embryos and cells perform better than those frozen/thawed. In fact, fresh embryos can perhaps produce about 10% higher pregnancy rates than their frozen thawed counter parts perhaps due to physical damages or excess reactive oxidant, nitrogenous, and sulfuric compounds, effect on organelles. The damage to these organelles induced by temperature depression can negatively affect the cells' ability to function as well as a ‘pre-temperature depressed’ cell.

A common issue that may result from in vitro handling and temperature depression may be exposure to bacterial compounds, free radicals, reactive compounds, ultraviolet exposure, xenobiotic compounds and the like that may generate high levels of at least two detrimental families of compounds, reactive nitrogen species and reactive oxygen species. While these compounds may be required for normal cellular function, excessive quantities internally or within a surrounding microenvironment, may in turn cause organellular, including mitochondrial damage resulting in ATP depletion, and perhaps even altered calcium oscillations. Moreover, breaking may occur within DNA and even altered membrane phospholipids. In addition, organelles may change their orientation within a cellular space causing disfunction. There may be a correlation between healthy mitochondria and perhaps the developmental competence of oocytes (unfertilized eggs). Exposure to reactive species may damage DNA integrity which may have a direct link to oocyte development and may be linked to increase competence later in development In the case of oocytes for example, cryoprotectant induced damage may cause parthenogenesis (spontaneous asexual formation of a diploid cell from a haploid cell), structural changes such as zona hardening and as but one more example, premature release of cortical granules.

Another issue plaguing cryopreserved cells may be exposure to foreign contaminants. While cells or tissues such as oocytes and embryos may be cultured and even matured in a sterile environment, storage environment such as liquid nitrogen may not be inherently sterile and can preserve harmful containments that can then be transferred to the previously clean cells, tissues or other materials. Bacteria and other moieties may be transferred from one loci to another within a cooling, or a cyro-solution such as perhaps liquid nitrogen or placement in vivo. This risk may be especially grave when an open cryopreservation system may be utilized. Contaminants may include bacteria, viruses, fungi, algae, physical objects, fragments of foreign materials, and the like, collectively referred to as foreign compounds.

A freezing technique known as vitrification may be utilized to avoid some mechanical damage during temperature depression of in vitro cells by freezing at such a rapid rate possibly around −3000 to perhaps more than about −25,000° C./minute the liquid may enter a glass-like state without ice crystal formation. However, even with vitrification there may be damage induced perhaps by the high osmotic levels of cryoprotectant required. Vitrification devices such as the Cryotop® from Kitazato Ltd. Tokyo, Japan, Cryoloop® from Hampton Research, Laguna Niguel, CA, USA, VitriFit™ from Cooper Surgical, Denmark, and similar devices may be commonly used. In addition, specific protocols that use various form of nitrogen including nitrogen slush, liquid nitrogen, and nitrogen vapor to cool and preserve gametes may also be utilized.

Alternative preservation methods of cells, tissues, and organs may include methods of temperature depression known as directional freezing, freeze drying, and similar techniques. Each of these is fraught with challenges that impart damage like that described above, or perhaps even more than described.

Finally, after temperature depression, and warming or thawing, the success of the transition from in vitro to an in vivo environment may not only be dependent on the quality of the materials being transferred but also the preparation of the recipient environment. It also is known that preparing the embryo recipient for transfer before transfer may be vital for success. Synchronizing the recipient and transferring a similar staged embryo improves pregnancy rates. An invention that mitigates post-temperature depression in addition to preparing recipient uterus is vital to in vitro transition to in vivo, and success. A method that increases the health of the environment and likely reduces the probability for infection is also may be vital to the success as the cells is transferred. As but one example, the success of pregnancy with in vitro fertilization and production may be dependent upon embryo quality and uterine environment quality.

Prior attempts using systems with additives may still be unable to fully protect cells, embryos, and tissues from the harmful exposures within in vitro and cryopreservation. Generally known are methods to combat some of the in vitro challenges including 1) adding cryoprotectants in a step-wise manner, 2) gradually increasing the concentration, and/or 3) adding them at reduced (refrigerated) temperatures. Yet, none reference to the relocation of organelles within the 3-dimensional environment of the cell nor perhaps to maintaining a pre-temperature depression, or in vivo state. Prior attempts do not address DNA nor other cellular organelles such as golgi bodies, endoplasmic reticulum, nucleus, lysosomes and other such organelles. In addition, prior attempts do not address protection and maintenance of such organelles including perhaps even plasma membrane, spindles, membranes, but rather replenishment which implies damage has occurred in a previous step of the process. Moreover, the addition of antioxidants might limit the focus to but a subset of damaging moieties and perhaps does not consider other reactive compounds such as nitrogen- and sulfur based, and the like. Perhaps antioxidant addition at indiscriminate levels may be fraught with challenges as a certain level of oxidants, and may not consider that some oxidized compounds are required for cellular functioning. Perhaps levels have not been taught before that create such a balance within an in vitro cell to maintain homeostasis.

Prior art does not teach amendment of existing media or use of reducing compounds. Moreover, the prior art may not teach a functional value of antioxidants nor perhaps does it speak to preventing damage rather only replenishing and repairing such damage. Prior art does not focus on amending or modifying cryopreservation solution themselves or what happened with specimens upon thawing.

Some prior art may focus on techniques and tools used for vitrification and cryopreservation but may not focus on media to reduce detrimental impacts to cells before, during, and even after temperature depressive events, nor may it focus on maintaining in vivo like cellular homeostasis, reducing impact of external contaminants, nor preparation of the environment into which cells or tissues are to be utilized.

### DISCLOSURE OF INVENTION

Accordingly, the present invention includes a variety of aspects or embodiments which may be selected in different combinations based upon the particular application or needs to be addressed. In various embodiments, the invention may provide methods and systems to reduce detrimental impacts to specimens such as cells, tissues, organs, oocytes, embryo, sperm or the like from effects induced by in vitro temperature depression including cooling, cryopreservation, vitrification, directional freezing, freeze drying, or the like. Methods and systems may be used to reduce variation within cells and may even make changes within 3-dimensional organellular distribution which may include, but is not limited to, membrane stabilizers, protective compounds, and perhaps other moieties in unique methods and systems. Embodiments of the present invention may improve or even maintain the in vivo quality, integrity, homeostasis, and perhaps functionality of materials post-temperature depression and even warming. These methods and systems may be compatible with current techniques such that the invention may serve to further improve existing technologies.

Additives perhaps with appropriately assessed levels of reducing compounds, organellular protectants, or even membrane stabilizers may be applied at a key point in a process which may help mitigate harmful effects to the developmental potential of cells or tissues by maintaining the in vivo homeostasis of an in vitro cell. Additives may help to regulate the microenvironment surrounding the cells or tissues perhaps also maintaining the in vivo homeostasis status.

Embodiments of the present invention may provide natural anti-pathogenic, antibacterial and perhaps antiviral compounds. In addition, aspects may aid in defense against other foreign contaminants within the cooling, freezing, storage, liquid nitrogen storage areas, during the temperature reduction process, or even during the warming or placement processes.

Further, embodiments of the present invention may provide a protecting agent which may even coat cells or tissues perhaps at key steps during a process which may enable a cell or tissue to better perform its desired functionality post-thaw perhaps because the cells or tissues may not have not undergone significant changes from the in vivo state.

Embodiments of the present invention may contain a system and method that prepares, or even increases the receptivity of, a recipient environment for an in vitro cell. Preparation methods may include, but is not limited to, decreasing inflammation, decreasing the presence of immune-response compounds, decreasing induced reactive compounds, and other such responses to introduction of a perceived foreign compound(s), tissue(s), cells.

Naturally, further objects, goals and embodiments of the inventions are disclosed throughout other areas of the specification, claims, and drawings.

### BRIEF DESCRIPTION OF DRAWINGS

FIG. 1 shows a non-limiting example of a vitrification procedure in accordance with some embodiments of the present invention.

FIG. 2 shows a non-limiting example of a vitrification medium and procedure in accordance with some embodiments of the present invention.

FIG. 3 shows a non-limiting example of a cryopreservation device and methods in accordance with some embodiments of the present invention.

FIG. 4 shows a non-limiting example of a cryopreservation device process in accordance with some embodiments of the various embodiments of the present invention.

FIG. 5 provides a non-limiting example of a warming medium and procedure in accordance with some embodiments of the present invention.

FIG. 6 provides a non-limiting example of a base stock solution and potential resultant solutions containing a base stock solution in accordance with some embodiments of the present invention.

FIG. 7 provides a non-limiting example of an in-situ placement device in accordance with some embodiments of the present invention.

FIG. 8 represents mitochondrial and organelle dispersion in accordance with some embodiments of the present invention.

FIG. 9 demonstrates how mitochondria may cluster as a sign of in vivo-like competence after maturation and also demonstrates damages possibly accrued during cryopreservation in accordance with some embodiments of the present invention.

FIG. 10 shows a graph of optimal total antioxidant reactivity (TAR) values in accordance with some embodiments of the present invention.

FIG. 11 shows negative effects of using too many reducing compounds within an in vitro production medium in accordance with some embodiments of the present invention.

FIG. 12 shows a non-limiting example of a specimen within an environment in accordance with some embodiments of the present invention.

FIG. 13 shows a graphical representation of the negative impacts of too much reduction capacity on cleavage rates in bovine embryos.

### MODE(S) FOR CARRYING OUT THE INVENTION

It should be understood that the present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. The specific embodiment or embodiments shown are examples only. The specification should be understood and is intended as supporting broad claims as well as each embodiment, and even claims where other embodiments may be excluded. Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

It may be understood that attempts at preserving the cellular homeostasis of in vitro cells during temperature depressive events by methods such as perhaps adding different cryoprotective compounds although theoretically protective, has been fraught with hurdles of cryotoxicity, including rendering the cells sub-viable, non-viable, decreasing motility, organellular damage, and/or even failing to confer protective benefits, or the like. It may be desirable to maintain in vivo-like functionality and physical attributes of cells in an in-vitro temperature depressed state and even when warmed and/or placed in a new in vivo setting. This may be accomplished by protecting the integrity of the cell, or tissue, maintaining the homeostatic balance, providing protection from external and internal contaminants, providing exposure to an optimum amount of reducing compounds, maintaining the organellular stratification within the 3-dimensional cell environment, and the like.

Many current media supplements may target but one facet of cell culture and protection, however embodiments of the present invention may cover many perhaps with the unique properties of plant-derived extracts such as might be isolated from any number of plant products and its potential to act as an anti-microbial or antipathogenic agent, reducing agents, cellular stabilizers, cell membrane and DNA protectant, pathogen-suppressing compounds, and act as protective agents from in vitro environmental contaminants, or the like. Similarly, individual components, chemically derived, functional compounds or moieties of the plant extracts might be utilized to mimic the functionality of the plant-derived extracts. Embodiments of the present invention may relate to the use of plant extracts. Plant-derived extracts, aqueous solutions, and/or lipid-based materials, or the like may be added to temperature depressive media including cryopreservation, vitrification, extender, or cooling media.

Embodiments of the present invention may be applicable to incorporation with a wide variety of commonly utilized media for cryopreservation. These media may include, but are not limited to: ABT360 (Washington, United States); ABT Complete Flush; ABT Holding; ABT Freeze; ABT ethylene glycol freeze with and without sucrose; ABT 1 and 3 step thaw; ABT Equine Vitrification and ABT Equine Uterine Lavage; CooperSurgical's (Demark) ProH; SAGE™ Vitrification Kit; Medicult Vitrification Cooling; SAGE™ CSC (Choline Substituted Cryopreservation) Freezing Medium; Global® Blastocyst Fast Freeze and Thawing Kits; Quinn's Advantage™ Blastocyst Freeze Ki; Quinn's Advantage™ Embryo Freeze Kit; Embryo Freezing Pack; Ivfstore's VitriBlast™ and ThermoBlast™ (Georgia, United States); IVF Limited T/A IVF Bioscience, Falmouth, Cornwall; United Kingdom's Vitricool and Vitriwarm; Vitrolife (Sweden) provides: RapidVit™ Oocyte, RapidVit™ Blast, RapidVit™ Omni, RapidVit™ Cleave; Krishco Medical Products Pvt. Ltd. (Banashankari, Bengaluru); Karnataka's Fertivit Cooling Kit; Fertivit Warming Kit; Irvine Scientific's (Santa Ana, Calif., USA) Embryo Freeze Media Kit and Embryo Thaw Media kit; Kitazato Minato-ku, (Tokyo, Japan), provides Vitrification Media VT801 and VT601 kits, or the like. Embodiments of the present invention may be compatible with commercial cryopreservation equipment, media, or the like.

Embodiments of the present invention may include a method of reducing detrimental impacts to in vitro and in vivo-derived samples due to temperature depression comprising the steps of providing a supplement to a medium; placing a specimen in said medium; subjecting said specimen to a temperature depression process; maintaining in vivo homeostasis in said specimen from before said temperature depression process to after said temperature depression process; and perhaps even maintaining in vivo like organellular function and organization in an in vitro cell.

Embodiments may provide a method of protecting in vitro samples from temperature depression damage comprising the steps of providing a medium; forming a droplet comprising a specimen and said medium; creating a protective layer around said droplet containing said medium and specimen; and perhaps even subjecting said droplet with said protective layer to a temperature depression process.

Embodiments may provide a multifaceted reducing compound during temperature depressing events.

Other embodiments may provide a method of exposing an in vitro sample to a recipient environment comprising the steps of providing a specimen in a medium which has been subjected to a temperature depression process and re-warmed; treating a recipient environment with a solution before implantation of said specimen in said medium; and perhaps even implanting said specimen in said medium into said recipient environment.

Yet other embodiments of the present invention may provide a method of protecting in vitro species by regulating reducing compounds to achieve a biochemically relevant balance comprising the steps of providing a specimen; providing a blend comprising chosen from thiols, polyphenols, phospholipids, glycolipids, flavonoids, phenolic acids, flavones, anthocyanin, carotenoids, quercitin, isohamnetin (I) glycoside, ellagitannins, quercitin-3-glycoside, polar lipids, terpenes, kaempferol, oleanolic acid, triterpenoids, ursolic acid and fatty acids; reducing reactive compounds containing nitrogen, oxygen, and sulfur in said specimen to render them non-detrimental; adding said blend to said specimen; and perhaps even subjecting said specimen to a temperature depression process.

Embodiments may provide a method of protecting in vitro and in vivo derived samples from temperature depression comprising the steps of providing a medium; placing a specimen in said medium; subjecting said specimen to a temperature depression process; and perhaps even providing a total antioxidant reactivity (TAR) value of said medium of between about 0.2 and 1.29 μM Trolox Equivalents. As another measure, a CUPRAC value of at least about 600 μM copper reducing equivalents.

Embodiments of the present invention may provide systems for transitioning a specimen from (A) a warm (e.g., body temperature) state to (B) a temperature depressed state to (C) a warmed, body temperature state again, and (D) a functional state where changes within a cell are minimized and perhaps functionality has been improved. Embodiments of the present invention may provide systems to assist in the transition between body temperature, cooling, freezing, room temperature or body temperature, and perhaps even implantation, or further culturing, fertilization or other uses with various specimens.

Embodiments of the present invention may be used with vitrification, slow cooling, slow freezing, cryopreservation, and perhaps even other cryopreservation techniques such as rapid laser cooling, freeze drying, directional cooling, and other such techniques that may preserve specimens such as cells, tissues, materials, or the like. Embodiments may also be used with cooling using simple methods of evaporative cooling, passive cooling, water bath cooling, or the like. Of course, this may be used in combination with cells, tissues, sperm cells, oocytes, embryos, or the like and perhaps at a variety of starting temperatures or the like. Embodiments may be used with a variety of end or even storage temperatures and may provide systems that may allow it to be used with liquid nitrogen, a nitrogen slush, or perhaps even nitrogen vapor, or the like. Similarly, use with systems that freeze materials, then desiccate the materials so they can be stored long-term at perhaps room temperature may be applicable. Embodiments of the present invention may include use with programmable rate coolers or freezers.

Embodiments of the present invention may assist in maintaining the in vivo homeostasis of cells or tissues though perhaps an induction of an appropriate microenvironment surrounding the cell or tissue. Such microenvironment might be maintained regardless of transition to multiple media, and perhaps even regardless of the type of media. Such homeostasis may refer to the maintaining of appropriate levels of reducing compounds to rid the micro, macro and intracellular environments of reactive compounds such as metals, nitrogenous compounds, reactive sulfur compounds, proteins, and oxygenated moieties that are at detrimental levels. Such homeostasis may include prevention of reactions such as the fenton reaction that may prove detrimental to the maintenance of in vivo-like cell quality. It may also include the effects of nitrogenous compounds such as urea, amine and guanidine that may cause protein denaturation. In addition, it may include environmental compounds that may impact the cell or medium including ozone, ultraviolet light and the like. It is important to note that because reactive compounds can interact with one another, it is important to address all reactive compounds in the medium, creating a balance of said compounds such that they catalyze cellular reactions but do not interact with one another creating and indeed catalyzing further negative effects. Moreover, reactive nitrogen and reactive oxygen compounds can catalyze an interplay between- and within- intracellular sources of said compounds. As but one non limiting example, reactive oxygen species may be generated by soluble cell components in the cytoplasm, by oxidases in the peroxisome or perhaps by lysosomes. The endoplasmic reticulum may also have a role. Within the cell, nitric oxide in the lysosome may produce superoxide and nitric oxide to form peroxynitrite and hydrogen peroxide then giving rise to hydroxyl radicals and nitric oxide radicals. These radicals are membrane permeant and can be transported into the medium catalyzing damage perhaps to increase membrane permeability and promoting other cascade reactions such as DNA degradation. Therefore, the interplay between the in vitro environment and the in vivo, and indeed, cellular biochemical reactions must be addressed by any media into which a cell will be held.

Further, embodiments of the present invention may assist in the prevention of damage catalyzed by failure of other systems within the in vitro processes. As but one example, changes in pH of the medium in which an embryo is held, caused by an improper balance of environmental gases, can catalyze production of reactive compounds within the cell that would not occur at a proper pH. As these compounds are released into the environment surrounding the cell in an unabated fashion, they will cause cellular damage. The disclosed invention may maintain the homeostatic balance of environment thus counteracting the negative effects of a pH change and maintaining cellular health.

Embodiments of the present invention may provide a supplement to a medium in which specimens may be placed or which may be added to a specimen. Media may be a blend of components. Some media may include trace minerals, reducing agents, zinc, selenium and other components, or the like that may be beneficial to the cell, or tissues. The medium may be added variably perhaps dependent upon the step of the process or may be focused on the biological needs of specimen at each specific step. Media may include components such as plant extracts, could be components of the extracts, or the like. Media may include various elements that can be beneficial to in vitro cells and tissues as they undergo temperature depression including but not limited to components such as calcium, phosphorus, chromium, copper, manganese, nickel, strontium, vanadium, iron, molybdenum, zinc, tin, selenium, boron, barium, aluminum, titanium, lithium, cadmium, lead, any combination thereof, or the like. Other components may include reducing sugars, cytochrome P450 and glucose oxidase compounds, vitamin C, carotenoids, mannitol, sorbitol, xylose, malic acid, d-Malic acid, citric acid, tartaric acid, succinic acid, protein, aspartic acid, quercetin, isorhamnetin I glycoside, carotenoids, flavonoids, diglycosides, monoglycosides, ellagitannins, quercetin-3-glycoside, glycosylated phenolic compounds, anthocyanin, phenolic acids, flavones, phenolic acid, edaravone, NXY-059, allopurinol, L-arginine, aminoguanidine, 7-nitroindazole, tirilazad, ARL 17477, 1400W, uric acid, resveratrol, L-carnitine, acetyl-L-carnitine, N-acetyl-L-cysteine and α-lipoic acid, curcumin, green tea catechins, caffeic acid, melatonin, edaravone, ebselen, cerium oxide, betulinic acid, any combination thereof, or the like. It should be understood that the various components, compounds and elements may be used in combination with one another or added individually, to a medium perhaps resulting in improved success of temperature depression and functionality post-warming or thawing and within the in vivo environment. Such compounds may also be added to any step of the in vitro process enabling the maintenance of in vivo-like health.

In embodiments, components may be added to a medium. Such components may include lipids, long chain sugar components, palmitic acid, palmitoleic acid, stearic acid, oleic acid, 11-octadeconoic acid, linoleic acid, linolenic acid and perhaps even nervonic acid in combination or singularly or the like. Lipids and associated components may be added at a level so as to avoid toxic effects. In addition, components may contain carotenoids, sterols, cholesterol, campesterol, stigmasterol, β-sistosterol, tocopherols, tocotrienols, phenolic compounds, amino acids, sugars, phytosterols, terpenoids, flavonoids, diglycosides, phenolic acids, flavones, flavonoids monoglycosides, phospholipids, glycolipids, glycosylated phenolic compounds, anthocyanin, carotenoids, quercetin, isorhamnetin (I) glycosides, ellagitannins, quercetin-3-glycoside, unsaturated fatty acids, palmitoleic acids, saturated fatty acids, polar lipids and any combination thereof or the like. Components using lipids may be in combination with traditional cryoprotectants, added sugars or the like. Lipids may be used at lower concentrations, may serve as an alternative cryoprotectant, or may even serve to reduce the toxic impacts of traditional cryoprotectants. This combined lipid and traditional cryoprotectant combination can be added to any specimen such as a variety of cell or tissue types including embryos, sperm, oocytes, stem cells as but some non-limiting examples perhaps to decrease cellular water (e.g., increasing solute concentration) which may protect the specimen during temperature depression events such as cryopreservation and vitrification.

Embodiments of the present invention may provide a method and additives that, in combination with traditional compounds, may help to regulate the osmolality within the cell. This may be used with temperature depression processes that reduces a temperature to less than or equal to about −6° C. Embodiments of the present invention may allow reduction in the amount of traditional or chemical cryoprotectant that may be required for vitrification or even cryopreservation. Such components may include naturally occurring osmolytes such as sugars, amino acids, methylamines, polyols, lipids, and the like. Some embodiments of the present invention may include a medium with glucose, sucrose, fructose, methyl cellulose or trehalose or any other combination of the aforementioned cryoprotectants, or the like perhaps to modify the osmotic pressure to perhaps about 800 to perhaps over about 9000 mOsm. As to commonly utilized cryoprotectants, a medium may include some or part of the following traditional cryoprotectants: glycerol, propylene glycol, propanediol, ethylene glycol, choline chloride, hydroypropyl cellulose, trehalose, sodium chloride, potassium chloride, magnesium sulphate, potassium dihydrogen phosphate, sodium bicarbonate, dimethylacetamide, dimethylforamide L-proline water, 2-methyl-2,4-pentanediol, trimethylamine oxide, glucose, calcium lactate, sodium pyruvate, EDTA, HEPES, sucrose, DMSO, ficoll, calcium chloride, gentamicin sulphate, glutamine, human albumin solution, magnesium sulfate, sodium lactate, sodium pyruvate, 1,2-propanediol, propyl alcohol, glycerol, galactose, any combination thereof, or the like.

The present invention may provide, in embodiments, an ice crystal nucleator which may be a result of using certain extracts or the like. In other embodiments, the present invention may serve to physically inhibit ice crystal formation. Media may protect the cryopreserved or even vitrified oocyte, embryo, cell, tissue, or collection of tissues from damage by ice crystals, aiding in the functionality of the traditional cryoprotectant.

Embodiments may address the need to reduce compounds such as superoxide, superoxide anion radical, peroxide, hydrogen peroxide, hydroxyl radical, hydroxyl ion, glutathione, sulfonic acid, sulfinic acid, sulfenic acid, nitric oxide and nitrogen dioxide radicals, hypochlorous acid, peroxynitrite, heavy metals, ozone, ultraviolet light in an incomplete manner allowing the maintenance of in vivo homeostasis within the in vitro cell, cells or tissues. It may be that the need for such reactive compounds in the cell, tissues or perhaps the environment necessitate a lack of complete reduction to prevent change from the in vivo state for cell, cells or tissues.

Embodiments of the present invention may provide a balance of reducing compounds that may be added to a medium perhaps in such a manner as to be sufficient to rid the specimen and medium of endogenous and exogenous reducing compound which may be above the biologically relevant concentration necessary for cellular functionality and in vivo homeostasis and below a detrimental concentration such as to impair cellular functioning. Methods which can serve as a way to measure the appropriate concentration of reduced compounds include Total Antioxidant Reactivity (TAR value), FRAP, CUPRAC, DPPH, ORAC, dichlorodihydrofluorescein diacetate, probes such as Amplex red, NADH-assays, dihydrorhodamine 123, dihydroethidium, lucigenin, luciferin, and lucigenin based assays, coelenterazine, Mito-SOX, MitoTracker, EPR spin-trapping spectroscopy, cytochrome C reduction assay, nitroblue tetrazolium, HyPer Probe, MitoBand, HKGreen-1, or the like. Similar assays may be used which can measure free radicals, redox status, nitrogenous and sulfur compounds, in vivo, ex vivo, in vitro or within medium surrounding a specimen or within a microenvironment of a specimen.

The assays may be benchmarked against one another perhaps so that the value representing an appropriate concentration of reducing compounds may require only a singular assay. A non-limiting example may include using a TAR value as the assay utilized to assess the value. An appropriate TAR value can be correlated to any of the other assays such that it may be standardized and understood across inventions and laboratories.

Compounds within a specimen or produced by metabolic processes, that may require reduction or even regulation include, but are not limited to singlet oxygen, hydrogen peroxide, hydroperoxyl radical, hydroxy radical, superoxide anion, ozone, hypochloride anion, hydroperoxide, peroxyl radical alkoxyl radical, nitric oxide, nitrous oxide, peroxynitrite, nitrogen dioxide, dinitrogen trioxide, peroxynitrous acid, nitroxyl anion, nitrosyl cation, nitrous acid, nitrosyl chloride, nitrite, nitronium ion, nitrosthiols, reactive metals, heavy metals and the like. These compounds may be necessary at some minimal level within a cell or within the surrounding environment perhaps to help regulate cellular processes. Yet the excess of any of these compounds in singular or in combination can result in irreparable damage or death. Excess peroxynitrite may be highly permeable within lipid bilayers and it may inactive some extracellular defense mechanisms such as perhaps superoxide dismutase. Moieties within a medium at concentrations that may be optimized to achieve and allow such a metabolic homeostasis may be required for proper post-thaw/post-warm, in vivo-like functionality.

Embodiments including media may contain specific compounds for a specific type of handling, a specific species from which a specimen may be derived, or perhaps even a specific type of temperature depression, or the like. A method used to add the components may be dependent on the specific conditions used for holding and treatment, may be dependent on cell type, and may be dependent on the size and type of microenvironment anticipated. In addition, beneficial components may be modified for the specific step or steps and may be optimized to provide the correct type of biological response within the cell or tissue within each step.

Embodiments of the present invention may utilize a protective agent. Protective agents may include a singular compound or group of compounds that can reduce detrimental impacts of temperature depression processes. Such impacts include variation or even changes within organelles, organellular rearrangements within the 3-dimensional environment, reduction of compounds that are reactive within a cell, excreted by the cell, excreted by intact or damaged organelles, or even within the external environment, or the like. Protective agents can impact which compounds may be required or even minimize compounds that may be required (such as cryoprotectants). Protective agents may comprise the microenvironment or perhaps the entire environment surrounding the cell or tissue or may be layered upon the microenvironment.

A temperature depression process may include freezing, cryopreservation, vitrification, slow cooling, cooling, and the like whereby an in vitro specimen (such as a cell, tissue or group of cells or tissues) may be decreased in temperature. This may indicate a target temperature of about 17° C., about 4° C., about −20° C., about −80° C., about −196° C., a temperature that is less than about 37° C., a temperature that is less than a body temperature, or the like. A temperature depression process may include passive cooling that might be experienced when transferring embryos from one in vivo environment to a recipient environment perhaps referred to as the process of fresh embryo transfer.

A recipient environment may be any in vivo environment into which an in vitro specimen (such as a cell, tissue, collection of cells, or the like) may be placed. Non-limiting examples of a recipient environment includes, but is not limited to, a uterus, a joint, a cavity, within an organ, an in vivo location, or the like.

A 3-dimensional distribution may include the distribution of organelles and cellular compounds in an in vivo cell prior to any manipulation or changes therein such as those caused by temperature depression processes. Organelles can be distributed within cells or collection of cells in such a way as to optimize functionality. Modification of such distribution could be detrimental to the ultimate functionality of a specimen when it may be transplanted into an in vivo environment.

During processing, handling, storage and even introduction into a recipient environment, specimens may be exposed to environmental contaminants. Environmental contaminants may include foreign matter, bacteria, fungi, algae, viruses, foreign tissue, foreign cells or foreign tissues carrying such foreign matter, pathogenic compounds, particles of dust, dust mites, other microscopic or macroscopic compounds, or the like that may result in negative issues to the ultimate functionality of the specimen.

In vivo homeostasis may include a balance within a cell of reduced compounds, oxidized compounds, sulfuric compounds, nitrogenous compounds, and other reactive species that can regulate cellular functionality within a body. Maintaining said balance of compounds in an in vitro environment may be necessary to induce an optimum response when specimens are reintroduced into a second in vivo environment. A non-limiting example includes the harvesting, freezing, and reintroduction of stem cells to and from a singular source or multiple sources. It should be understood that the same term may be encompassed when referring to homeostatic balance, homeostasis, in vivo homeostasis, and the like.

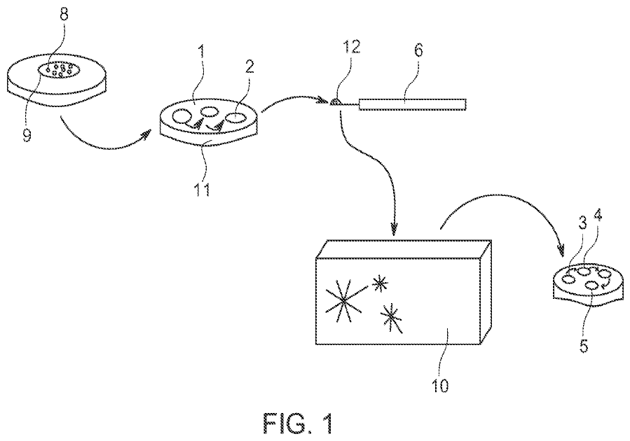

FIG. 1 provides a non-limiting example of a vitrification process. A specimen (8) may be collected, isolated, and even washed before being placed in a medium, perhaps a holding medium perhaps containing embodiments of the disclosed invention. A specimen (8) may include, but is not limited to, cells, tissues, organs, oocytes, embryos, sperm, a clutch, stem cells, hepatocytes, eukaryotic cells, prokaryotic cells, cell lines or clones, plant cells, lymphoblasts, fibroblasts, epithelial cells, or even lymphoblast-like, fibroblast-like, or the like. A specimen (8) may be moved to a dish (11) containing medium. A specimen may be moved from a holding medium (9) perhaps to an equilibrium medium (1) and then even to a vitrification medium (2). Once a specimen has been treated in at least one medium, which may include a holding medium (9), an equilibrium medium (1), a vitrification medium (2), or other medium, any combination thereof or the like, a droplet (12) of medium and the specimen may be formed. All media may perhaps contain embodiments of the disclosed invention. Droplets (12) may be loaded onto a device (6) such as, but not limited to, a vitrification device, a Cryotop® (Kitazato Ltd. Tokyo, Japan), a Cryoloop® (Hampton Research, Laguna Niguel, CA, USA), or the like. The device (6) having the droplet (12) thereon may be plunged into liquid nitrogen (10) or may be treated (FIG. 3) then plunged, and perhaps stored indefinitely. The specimen (8) may be thawed perhaps by immersion in a warming medium (3) or perhaps even in a series of warming media. A series of warming media may include a first warming medium (3), a second warming medium (4), and perhaps even a third warming medium (5), where a second warming medium may have a decreased osmolality than the first and the third may have a decreased osmolality than the second. The warming medium may slowly bring a specimen to physiologic levels. Then, a specimen (8) may be cultured, implanted immediately, placed in a holding medium, or the like.

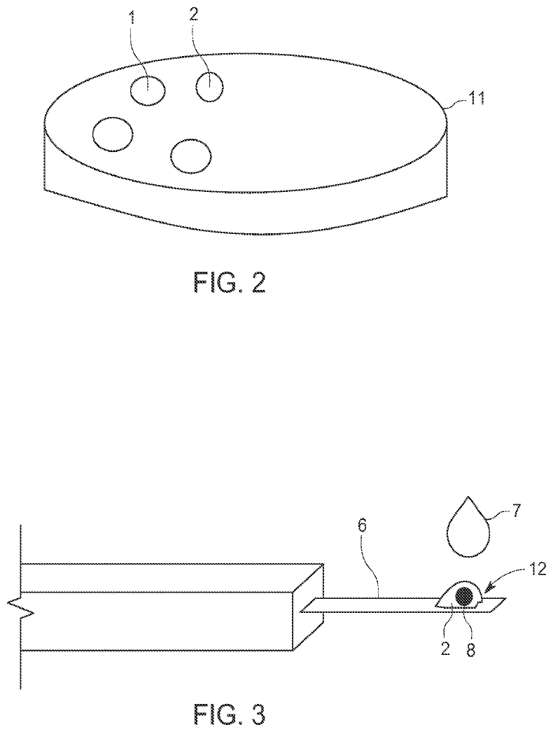

FIG. 2 shows a non-limiting example of a pre-vitrification process. Vitrification processing may include an equilibration medium (1) in a droplet (12) perhaps at an osmolarity perhaps with about one quarter to about half-way between an osmolarity of a holding medium (9) and a vitrification medium (2). A vitrification medium (2) perhaps in a droplet form (12) may hold a specimen for a limited time perhaps around 15- about 45 seconds before the specimen may be loaded and even plunged into nitrogen. All media may be held within a dish (11) such as a cell safe dish.

FIG. 3 shows a non-limiting example of a device (6) which can be a vitrification device like a Cryotop® (Kitazato Ltd. Tokyo, Japan), Cryoloop® (Hampton Research, Laguna Niguel, CA, USA), or the like. A device may be used to hold a specimen during storage in liquid nitrogen. A specimen (8) may be loaded on top of a device with some vitrification medium (2) perhaps to form a droplet (12). In one embodiment, a protective layer (7) may be added onto a droplet (12) perhaps in drop form or a bundle may even be dipped into a protective layer (7). A protective layer may be a solution, coating, additive and may include lipids, lipid-like components such as free fatty acids, long chain sugar components, unsaturated fatty acids, saturated fatty acids, polar lipids, sn-2 unsaturated fatty acids, palmitic acid, palmitoleic acid, palmitoeic, stearic acid, oleic acid, 11-Octadeconoic acid, linoleic acid, linolenic acid, phosphatidylcholine, phosphatidylinositol, phosphatidylserine, phosphatidic acid, diphosphatidylglycerol, phosphatidylethanolamine, diglactosidylacylglyerol, monogalactosydiaculglycerol, bees wax, honey, nervonic acid, mineral oil, liquid paraffin, polymers such as polysaccharides, suberin, melanin, lignin, cellulose, biological polymers, synthetic polymers such as polyethylene, polylactic acid, polylactic acid, in any combination or singularly, or the like. In addition, a shield may contain carotenoids, sterols (including but not limited to cholesterol, campesterol, stigmasterol and β-sistosterol, tocopherols and tocotrienols, or the like.

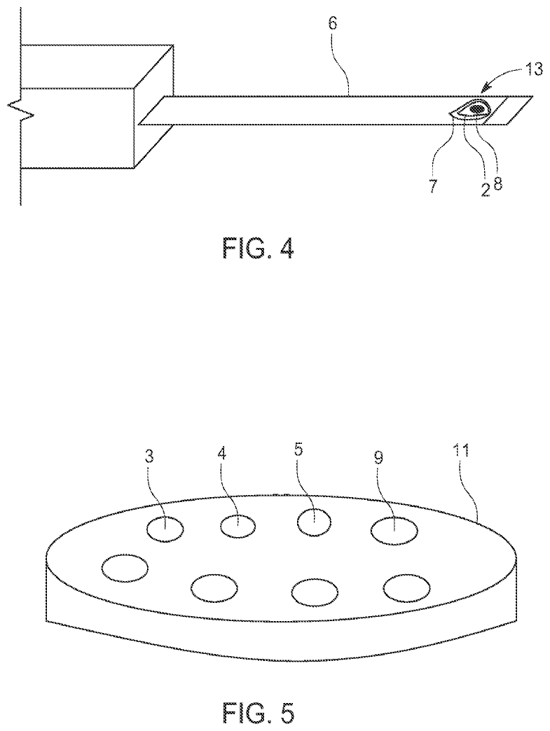

FIG. 4 shows a non-limiting example of a protective layer (7) surrounding the vitrification medium (2) containing the specimen (8), perhaps forming a protected specimen (13) on a device (6). The device may be plunged into liquid nitrogen and may be used to hold and store the specimen during vitrification.

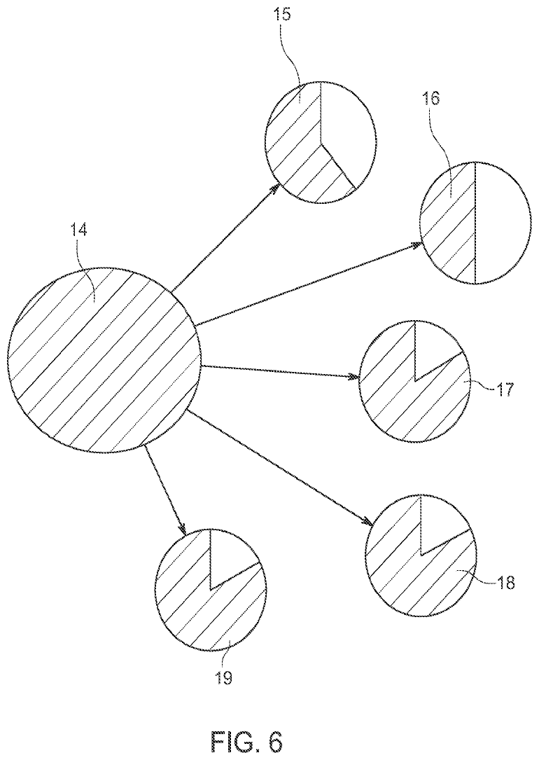

FIG. 5 shows a non-limiting example of a post-vitrification process. Media may be held in a dish (11). A first warming medium (3) may be a high osmolality droplet, perhaps over about 1000 mOsm, of which a specimen (8) or even a protected specimen (13) may be placed, shook, incubated, swirled, or the like. A second warming medium (4) may be about half osmolality droplet of a first medium of which a specimen (8) or protected specimen (18) may be placed perhaps after placement in a first medium. A third warming medium (5) may be about a quarter osmolality droplet of a first medium to which a specimen (8) or protected specimen (18) may be placed perhaps after placement in a second medium. A holding medium (9) may be a droplet to which a specimen (8) or protected specimen (18) may be placed perhaps after placement in a third medium and may hold a specimen (8) until ready to culture or other use. Specimen (8) may be held in each medium step for about 1-5 minutes before being transferred into another medium. Each of these media may be said to constitute a microenvironment surrounding said cell and may be amended to maintain, even for a brief moment, the appropriate homeostasis of compounds.

FIG. 6 provides a non-limiting example of the preparation of solutions. A solution may be a base stock solution (14) with may be used for various media. Said solution may be amended to contain compounds from within the invention that may then be distributed to other solutions. For example, each medium used for a vitrification pre- and post-processing may be derived from a base stock solution. A portion of a base stock solution (14) could be aliquoted perhaps for integration into other media at various percentages. Non-limiting examples of media that could be created from a base of stock solution include, but are not limited to about 25-60% equilibrium solution (ES) (15), about 50% vitrification solution (VS) (16), about 25-80% thaw solution (17), about 50-80% dilution solution (18), and perhaps even about 80% wash solution (19). The percentages may indicate an approximate amount of stock solution versus other ingredients within each solution.

It should be understood that the vitrification procedures and various media discussed herein could be supplemented with components for increased cellular health, homeostasis and functionality after cryopreservation.

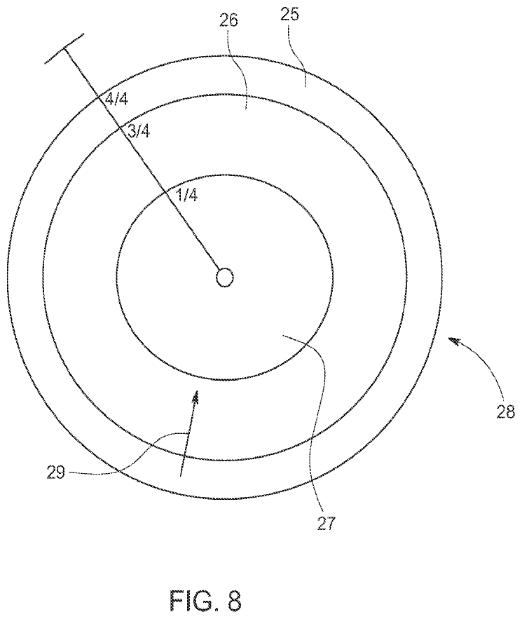

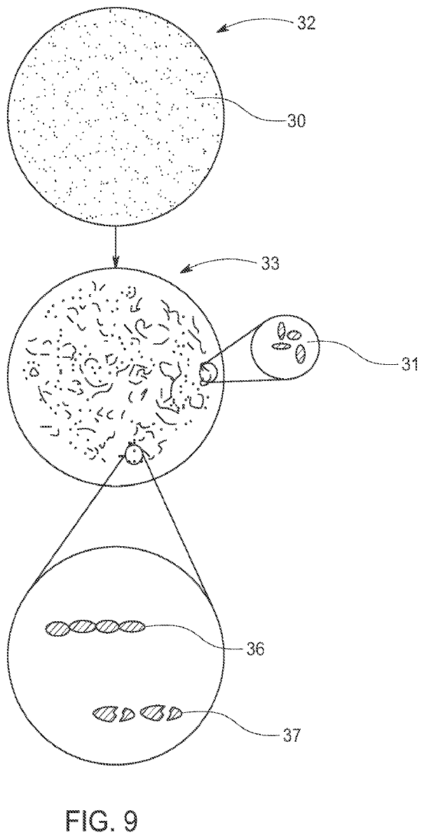

Within oocytes following maturation, mitochondria or perhaps other organelles can migrate from an outer cell inwards as demonstrated in FIGS. 8 and 9. FIG. 8 shows a non-limiting example of mitochondrial and organelle dispersion perhaps used as an indicator of cellular health. Mitochondria may disperse from mainly an outer cell area (25) with a few in the middle area (26), to evenly dispersed (29) across all three areas (25) (26) and (27) during oocyte (28) maturation. FIG. 9 shows a non-limiting example of how mitochondria may cluster as a sign of competence after maturation and cryopreservation. Individual mitochondria (30) and organelles can form groups of 3 (31) or more and perhaps more than about 40% of the cell can contain these groups. Oocyte mitochondria may shift from a granular position (32) during a GV (germinal vesicle) stage to a clustered position (33) during MII (meiosis II) stage as a sign of competence. If oocytes are damaged during temperature depression, the appropriate type of clustering may not occur. Further, oocyte damage can be expressed by the fission and fusion of mitochondria (36, 37) into perhaps an elongated network. Changes seen in mitochondrial function and arrangement within a 3-dimensional space may perhaps also occur with other organelles present in cells.

Embodiments of the present invention may limit cellular membrane reorganization, reorganization of mitochondria and reorganization of other organelles within the 3-dimensional environment, DNA integrity, endoplasmic reticulum, Golgi body locations and functionality, limit lipid oxidation and reorganization, oxidative stress to mitochondria and to other organelles, release of increased amounts of reactive compounds, disruption of cellular respiration, changes in calcium homeostasis, membrane permeability alteration, damage to mitochondrial defense system, induction of DNA mutations, phospholipid modification, or the like such that a cell may maintain its in vivo properties although it may be temporarily held in an in vitro environment. Embodiments of the present invention may positively affect the distribution of mitochondria in the cell or tissues including but not limited to oocytes, and embryos (FIGS. 8 and 9). Using the systems and methods discussed herein, mitochondrial function of an oocyte may be positively affected prior to, and perhaps even after vitrification, cryopreservation or freezing, and warming or thawing, such that it may function similarly to a cell that may not been cryopreserved or vitrified. Embodiments of the present invention may result in a mitochondrial distribution, indeed organellular distribution, of frozen specimens that may be identical to, similar to, or even like a non-cryopreserved specimen (such as a cell, tissue, tissues, organs).

Embodiments of the present invention may include to a method of protecting specimens (e.g., cells, embryos, oocytes, tissues, collection of tissues, gametes, germ cells, cell lines, stem cells, bacterial cells, plant cells, fungal cells, and algal cells) that may be stored directly in liquid nitrogen or in similar storage methods that maintain a temperature at or about −196° C., about −40° C., about −20° C., or other common storage temperatures. It may provide a method to protect the specimen from foreign compounds associated with storage directly in liquid nitrogen which may include bacteria, viruses, fungi, foreign bodies, and pathogens, or the like, (together pathogenic or foreign compounds). In embodiments, a solution or medium may be amended to contain naturally derived antibacterial, antiviral, antimicrobial and/or antifungal, or similar pathogenic suppressing compounds which may be derived from plants or other sources. These compounds may include, but is not limited to phytochemical compounds such as phenols, oxygen-substituted phenol derivatives, flavonoids, alkaloids, terpenes, phenolics and polyphenols, quinones, tannins, proanthocyanidins, egallic acid, norwogonin, chebulagic acid, chebulinic acid, coruagin, terchebulin, tanning, terpenoids, saponins, alkaloids, flavonoids, natural gums and resins, latex, phloretin, withaferin A, berbeine, catechols, eugenol, piperine, fructose, photoanemonin, salicylic acids, anthemic acids, capsaicin, cocaine, fabatin, allicin, ajoene, asiatocoside, lupulone, humulone, lawsone, alpinumisoflavone, glabrol, helanins, quercetin, hexanal, menthol, reserpine, mescaline, opium, petalostemumol, reserpine, rhein, carvacrol, caffeic acids, thymol, totarol, turmeric oil, essential oils, extracts form the Cameroonian plant, extracts from Hypericum, propolis, flavonoids pinocembrin and galangin, spermidine, rutin, quercetin, kaempferol, stigmasterol, campesterol, tocopherol, carotenoids, quaternary ammonium and glucosinolate, aliphatic constituents, lectins, polypeptides, polyacetylenes, flavones, flavonoids, simple phenols, phenolic acids, plant extracts containing such compounds, such as that from perhaps genres Rubus, Hippophae, Capparis, Melaleuca, Daucus, or complex plant extracts supplemented with any of the above, any combination thereof, or the like.

In yet other embodiments, an anti-pathogenic solution may serve to wash a specimen to be treated during the thawing process Washing may include physical, mechanical or even chemical means, or even denuding of foreign bodies relative to a sample. Similarly, such washing may serve to remove detrimental in vitro compounds perhaps, so they are not introduced into the in vivo environment.

In another embodiment, a coating that may be utilized to protect a specimen from exogenous compounds may be anti-pathogenic which may also serve to prepare a recipient environment.

Embodiments of the present invention may provide a protective shield to a specimen which may limit the exposure to harmful agents or foreign compounds, or the like (FIG. 3, FIG. 4). A protective shield/layer may a lipid shield over a specimen which may also contain antibacterial components perhaps as well as antimicrobial components. A protective shield may include, but is not limited to, free fatty acids, long chain sugar components, palmitic acid, palmitoeic acid, stearic acid, oleic acid, 11-Octadeconoic acid, linoleic acid, linolenic acid, phosphatidylcholine, phosphatidylinositol, phosphatidylserine, phosphatidic acid, diphosphatidylglycerol, phosphatidylethanolamine, diglactosidylacylglyerol, monogalactosydiaculglycerol, bees wax, honey, nervonic acid, mineral oil, liquid paraffin, polymers such as polysaccharides, suberin, melanin, lignin, cellulose, (biological polymers), synthetic polymers (polyethylene, polylactic acid, polylactic acid), in any combination or singularly, or the like. In addition, a shield may contain carotenoids, sterols (including but not limited to cholesterol, campesterol, stigmasterol and β-sistosterol), tocopherols and tocotrienols, or the like. A protective shield/layer may be applied to a specimen perhaps by droplets, layering of compounds, dipping of materials into said compounds, or the like.

Embodiments of the present invention may provide a protective layer that may guard against damage to a specimen perhaps induced by chemical and even biological compounds and moieties such as oxidants, sulfurous, nitrogenous compounds, foreign proteins and foreign lipids or the like. In embodiments, a lipid layer may be used to surround or even cover a specimen. In yet another embodiment, lipids may form a screen around a specimen. A screen or even coating may be directly in contact with a specimen, or may be in contact with the physical components of the freezing apparatus, may be in contact with a medium surrounding the specimen, or may form a protective layer or a solution coating the already frozen materials. A protective coating/layer may include components such as, but is not limited, vitamin E, about 30% or more saturated acids, unsaturated fatty acids, saturated fatty acids, polar lipids, sn2 lipids, phospholipids, palmitic acid, palmitoleic acid, C₁₆ fatty acids, C₁₈ fatty acids, oleic acid, phytosterols including sitosterol, and perhaps even carotenoids, any combination thereof or the like.

Embodiments of the present invention may include an emulsification system perhaps to enable mixing of a lipid with a medium to create a microenvironment which may be permeated with medium plus lipid. In other embodiments, the absence of the emulsification system may enable a formation of a distinct lipid layer over a specimen or even over medium containing a specimen which may then be vitrified or frozen.

Embodiments of the present invention may limit exposure to detrimental in vitro environmental contaminants while harvesting specimens. Harvesting can include biopsies, ovum pick-up, stem cell retrieval, maceration of organs, chemical means, physical means, and the like where in vivo cells and tissues are collected perhaps for in vitro processing or even temperature depression events.

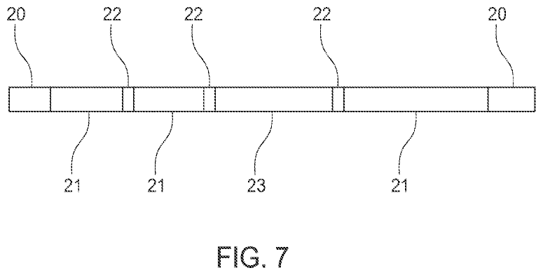

Embodiments of the present invention may include a preparing a recipient environment (41) for exposure to a specimen (40) (such as cells, embryos, oocytes, tissues, collection of tissues, gametes, germ cells, cell lines, stem cells, bacterial cells, plant cells, fungal cells, and algal cells. or the like) perhaps to be implanted. A recipient environment may be a uterine environment or the like. In mammals, uterine stress post-parturition is common, especially so in first calf heifers, leading to long periods between pregnancies due to damages and possible infections. Treatment of the uterine environment could perhaps reduce uterine infections, quicken uterine elasticity and return of strength to obtain perhaps quicker rebreeding status due to possible improvement of environmental receptivity. A method may include a lavage and perhaps even a treatment with plant related extract(s) capable of inducing localized natural hormone and gene expression necessary for optimum specimen and destination interaction. A further method may include debridement, rinsing, depth filtration, cell detachment, and the like. Treatment may occur prior to, during implantation or even during use of a specimen within a uterine environment. It may be important to evaluate the functionality of a specimen and even uterine environment that can occur concurrent with in situ implantation. As but one non-limiting example, FIG. 7 demonstrates where preparing materials may be delivered along with a specimen (e.g., an embryo or the like) to be implanted. In another embodiment, treatments to prepare a recipient environment can be delivered perhaps via the same methods that the recipient specimens may be delivered such as within implantation devices like embryo carrying straws, cell carrying straws, tubes or the like. In some embodiments, it may be desirable to freeze a specimen with certain medium perhaps for later implantation in mind. Preparation of the environment can occur simultaneously with application of specimen or within an appropriate prior timeframe to enable responses as may be desirable for success of implantation of the specimen. As but one non limiting example and embodiment, an uterus may be treated prior to insemination and may also be treated at the time of insemination to have provide an optimum opportunity for reception of said specimen.

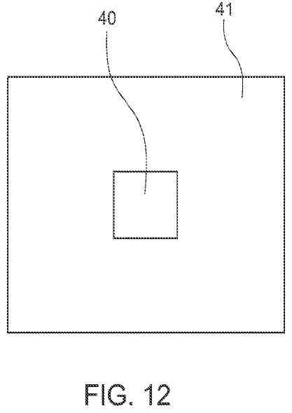

FIG. 7 provides a non-limiting example of a placement device (24) which may be a cryopreservation or perhaps even an in-situ placement device to place a specimen (34) in an environment (35) as may be understood in FIG. 12. A placement device may include medium (21), medium with specimen (23), air bubbles (22), a plug or sealing device (20), or the like. A specimen (8) may be in a medium (such as a cryopreservation medium, a uterine-priming medium, or the like). Medium may be supplemented with an additive as discussed herein to prepare a uterine environment which may act to increase the odds of a successful implantation and even pregnancy. Variable amounts of air bubbles (22) and medium pockets (21, 23) can be used. Each medium pocket may contain different components. For example as may be understood from FIG. 7, a placement device may be a tube with a plug or sealing device at the top, a first medium pocket which may be a cryopreservation-medium, then there may be an air bubble (22), then a second medium pocket which may have a cryopreservation-medium with a specimen therein (23), then another air bubble (22), then a third medium pocket which may have a different medium such as a uterine preparation medium, an air bubble, then a plug or sealing device (20) at the end. The amount of air bubbles can vary from perhaps 1-7 bubbles. Of course, any combination of medium pockets and air bubbles may be used, and all are meant to be incorporated in the disclosure of this application. For example, each medium pocket could be different, or each could be the same or similar or the like. An end medium pocket could possibly be different than the others such that it may contain a special blend of medium to prime, clean, treat, or perhaps modify the recipient environment or the like. Using the systems and methods discussed herein may aid or even speed the uterine environment recovery after parturition in addition to decreasing infection incidence.

Table 1 depicts all extracts used within all the experiments below.

TABLE 1

| Extract | | |
|---|---|---|
| Name | Primary Components | Secondary Components |
| Extract | phenolic compounds | Flavonoids, diglycosides, |
| A | | phenolic acids, flavones, |
| | | flavonoids monoglycosides |
| Extract | phenolic compounds | Flavonoids, diglycosides, |
| B | | phenolic acids, flavones, |
| | | flavonoids monoglycosides |
| Extract | phospholipids, glycolipids | |
| C | | |
| Extract | phospholipids, glycolipids | |
| D | | |
| Extract | glycosylated phenolic compounds, anthocyanin, | quercitin, isohamnetin (I) |
| E | carotenoinds, flavonoids | glycoside |
| Extract | quercitin, isohamnetin (I) glycoside, carotenoids, | |
| F | flavonoids, diglycosides and monoglycosides | |
| Extract | quercitin, isohamnetin (I) glycoside, carotenoids, | |
| G | flavonoids, diglycosides, and monoglycosides | |
| Extract | quercitin, isohamnetin (I) glycoside, carotenoids, | |
| H | flavonoids, diglycosides and monoglycosides, | |
| | ellagitannins, quercetin-3-glycoside, glycerol | |
| Extract | unsaturated fatty acids (50%), saturated fatty | 30% palmitoleic acid |
| I | acids (50%), 5% polar lipids, 10% phospholipids | |
| Extract | unsaturated fatty acids (80%), saturated fatty | sn-2 unsaturated fatty acids |
| J | acids (20%) | |
| Extract | glycerol, terpenes, flavonoids | Glycosides, kaempferol, |
| K | | oleanolic acid, triterpenoids, |
| | | ursolic acid, isohamnetin |

### Experiment 1: Antimicrobial

Compounds as may be utilized to decrease the impact of exposure to microbial compounds may include sea buckthorn (Hippophae) seed or pulp oil. In an experiment, a common freezing media for cells was prepared per industry standards except no antibiotics were added. The media was divided into equal parts. To 5 mls of media, 0.25 mls of sea buckthorn oil was added and mixed. To both parts 100 μl Escherichia coli (in exponential growth phase) was inoculated and allowed to incubate for 2 hours. An 11 μl of the samples were then plated onto blood agar plates.

Data in Table 2 are expressed as Colony Forming Units per ml of medium (CFU/ml) and demonstrates a significant decrease in the number of E. coli cells in the media when oils were included in the medium.

TABLE 2

| | | Inoculant density after 2 |
|---|---|---|
| Medium | Inoculant | hours incubation (CFU/ml) |
| Control egg yolk citrate | E. Coli | 21.2 × 10⁶ |
| Egg yolk citrate + sea | | 9.7 × 10⁶ |
| buckthorn oil | | |

### Experiment 2: Antimicrobial

Conducted per experiment 1 above except cultures were plated on lysogeny broth plates which were incubated for 24 hours at 37° C., and control solution was a TRIS buffer (2.42 gm % Trizma Base, 1.38% gm Citric Acid, 1.00% gm Fructose). Table 3 demonstrates a significant reduction in population density when oils were included in the buffering solution.

TABLE 3

| Medium | Population density (CFU/ml) |
|---|---|
| Control buffer solution | 204 × 10⁶ |
| Control buffer + sea | 6.8 × 10⁶ |
| buckthorn oil | |

### Experiment 3: Antimicrobial

Streptococcus zooepidemicus is a common opportunistic pathogen commonly found in the reproductive tract of animals and in mucosal-lined tissues and may be commonly transferred using artificial reproductive technologies as described below. Klebsiella pneumonia are bacteria commonly found in feces and intestines and can be transferred during artificial reproductive technologies. Similarly, Streptococcus equis is a common etiologic agent for upper respiratory disease in equine as well as disease state in cattle, sheep, pigs, and goats. It has been isolated from respiratory tracts and may be considered an opportunistic pathogen.

One (1) ml of flash-pasteurized medium was inoculated using a fresh BHI plate of S. zooepidemicus, K. pneumoniae or S. equis and incubated at 35° C. for 24 hours. 1 ml of medium was left as sterile media. The remainder was amended with one of the following treatments: Extracts A, C, D, E, I, and J. Components of these treatments are found in Table 1. 10 μl of inoculum was added to each of the above then vortexed. It was incubated for 24 or 48 hours, then prepared a dilution and plate on BHI plates. Each colony arising for each sample was counted. Each was replicated 5 times.

Results in Table 4 are a geometric mean of the data. The results demonstrate a reduction in bacteria population within the medium between about 50 and about 99% of the control demonstrating the effectiveness of various extracts. The presence of these within the media suppressed bacterial growth and can serve to protect the cooled, cryopreserved or vitrified specimens from inadvertent contamination.

TABLE 4
(All Population Densities in CFU/Ml and Abbreviated
As Millions (E.G. 10 × 10⁶ As 10))

| | | Percent | | Percent | |
|---|---|---|---|---|---|
| | Population | Reduction | Population | reduction | |
| | density (24 | relative to | density (48 | relative to | |
| Treatment | hours) | control | hours) | control | Inoculum |
| Control | 13.4 | | 5.8 | | S. zooepidemius |
| Extract E | .124 | 99.07 | .014 | 99.7 | |
| Extract I | 1.5 | 52.4 | .304 | 94.7 | |
| Extract J | 9.12 | 31.9 | 1.32 | 77.24 | |
| Extract A | 6.2 | 53.7 | 0.52 | 91.03 | |
| Extract C | 5.2 | 61.1 | .86 | 85.1 | |
| Extract D | <.002 | >99.9 | Contaminated* | n/a | |
| Control | 164 | | | | K. pneumoniae |
| Extract E | 20.8 | 87.3 | | | K. pneumoniae |
| Extract D | 18 | 89 | | | K. pneumoniae |
| Control | 12.8 | | | | S. equis |
| Extract E | 2.2 | 82.8 | | | |
| Extract I | 8.4 | 34.3 | | | |
| Extract J | 9.1 | 28.9 | | | |
| Extract A | 4.8 | 62.5 | | | |
| Extract C | 7.0 | 45.3 | | | |

*mold contamination across all replicates from technician error caused premature experimental end to this sample.

### Experiment 4: Antioxidant Capacity of Media Treated with Extracts

Compounds may be used to assist in reactive moiety mitigation within in vitro cellular production systems. In this experiment focusing on embryo production, 4 different media from 4 main steps of embryo production and culture were supplemented (in vitro maturation, fertilization, culture 1 and culture 2) with extracts A, B, E, or G to determine reducing compounds capacity to maintain a proper cellular in vivo homeostasis in supplemented media. Total antioxidant reactivity (TAR) values were compared to associated blastocyst rates produced by the supplementation to determine an optimal range (graph 1). TAR values are calculated using the following equation:

$$TAR ( µM Trolox ) = \frac{Σ ki [ x ] i}{{k}_{trolox}}$$

Ki represents the i-th compound reactivity and [x]i represents the i-th antioxidant in fluid. Extracts were also analyzed using CUPRAC assay.

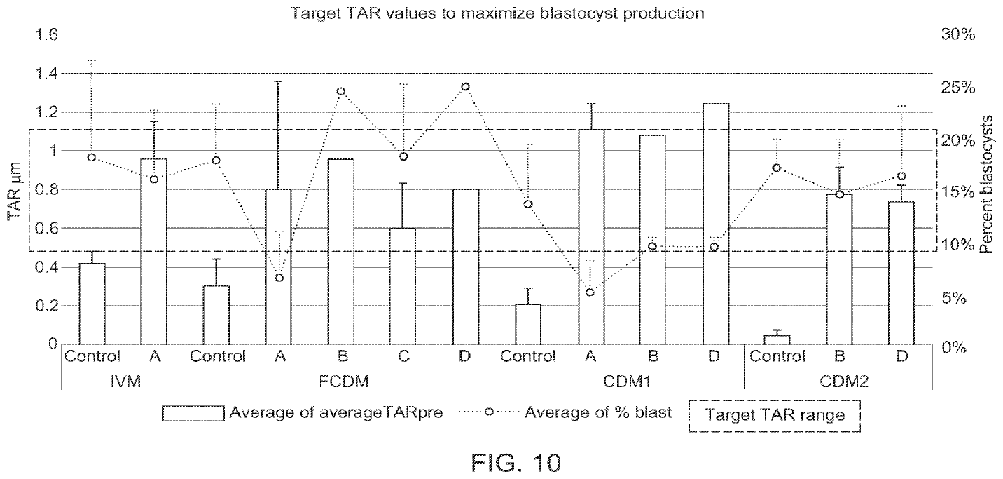

TABLE 5
Total Antioxidant Capacity Levels (μM trolox equivalents).
(See FIG. 10 for graphical representation of data.)

| Traditional | | | | | |
|---|---|---|---|---|---|
| medium | Control | Extract A | Extract B | Extract E | Extract G |
| In Vitro | 0.4 | 0.95 | | 0.37 | |
| Maturation | | | | | |
| Fertilization | 0.3 | 0.8 | 0.96 | 0.61 | 0.79 |
| Culture 1 | 0.2 | 1.11 | 1.08 | 0.39 | 1.24 |
| Culture 2 | 0.04 | | 0.78 | 0.30 | 0.74 |

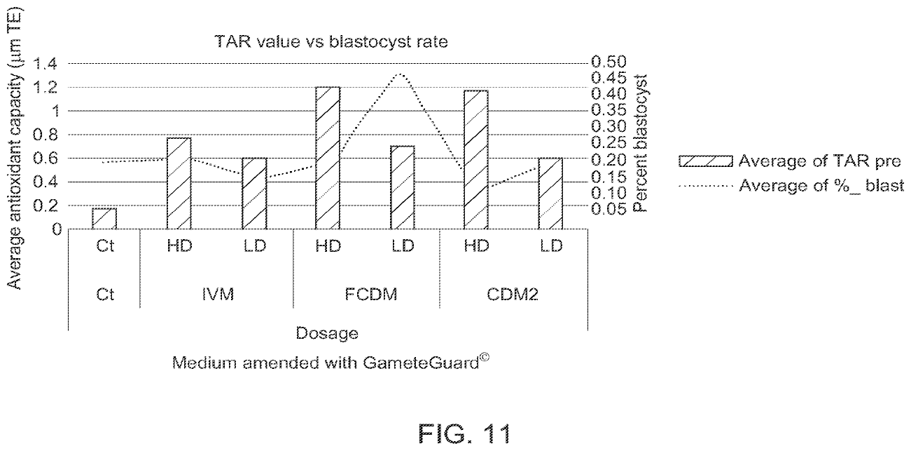

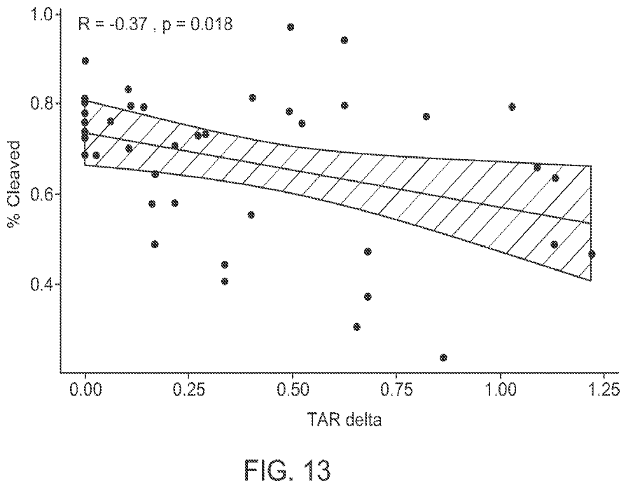

FIG. 10 provides a graphic of optimal total antioxidant reactivity (TAR) values in accordance with some embodiments of the present invention. Optimal TAR values of media in in vitro production of embryos can remain between about 0.2 and about 1.29 μM Trolox Equivalents for any given medium in the in vitro production process. FIG. 11 demonstrates negative effects of too much reduction compounds within an in vitro production medium and therefore TAR values should remain below 1.4 μM Trolox Equivalents. Depicted are high and low dose of Extract A (HD and LD) effect on blastocyst rates. Lower concentrations (TAR value in line with requirements of the cell) of Extract A in fertilization (FCDM) and culture medium (CDM2) resulted in higher blastocyst rates than high concentrations. Proper homeostatic balance is maintained because sufficient reactive compounds are present to catalyze required cellular actions. In vitro maturation (IVM) resulted in the highest blastocysts rates with higher concentrations of TAR. Too much reducing potential in FCDM and CDM2 resulted in the lower blastocyst rates demonstrating the negative effects of too much reduction in reactive compounds as illustrated by TAR value. FIG. 13 also depicts the negative effects of too much reduction compound within an in vitro production media, specifically fertilization medium. FIG. 13 provides graphical representation of the negative impacts of too much reduction capacity on cleavage rates of bovine embryos. TAR delta, the difference between TAR values of extract treated fertilization media to control media TAR values, was significantly negatively correlated to cleavage rates of in vitro produced embryos. This delta (as opposed to an absolute value) is important to consider when adjusting the concentration of reducing compounds within a given medium and must consider the biochemical processes that are occurring at the specific stage.

Table 6 demonstrates a second measure of the ability of extracts to remove harmful moieties from a solution. This second type of assay enables characterization of the potential to be effective in removing said moieties to maintain a proper homeostatic environment. The CUPRAC assay measures thiol-group compounds at a physiological pH, often providing a more accurate glimpse of the in situ functionality of the extract. Thiol-groups may function in removing both reactive oxygen and nitrogen compounds. Note, in several cases compounds were not measured at their use concentrations but rather slightly higher concentrations but these data provide a graphic demonstration of the breadth of negative moieties that may be impacted by the use of said extracts within a medium.

TABLE 6
Ability of extracts to remove reactive compounds from
a solution expressed as Cu reducing equivalents (μM)

| | Cu reducing | Percentage | Percentage utilized |
|---|---|---|---|
| Extract | equivalents | measured | in Table 5 |
| Extract E | 613.7 | 2.5% | 0.625% |
| Extract I | 1148.8 | 5% | 100% |
| Extract J | 967 | 5% | 100% |
| Extract A + B | 1290.4 | 2.5% | 2.5% |
| Extract K | 1479.3 | 2.5% | 1.25% |

### Experiment 5: Vitrification of Embryos with Extracts

The following experiment supplemented vitrification solutions with two different extracts directly prior to vitrifying one-cell mouse embryos as well as directly following vitrification with commercial solution. Equilibration solution (ES, 1), vitrification solution (VS, 2), thawing solution (TS, 3), dilution solution (DS, 4), and warming solution (WS, 5) (FIG. 1) were each amended with the same treatment or control. Embryos were thawed and culture to day 5 blastocysts and checked for cleavage as a sign of successful vitrification (Table 7). By comparing the ‘not vitrified control’ to those treated with Extract A, it can be seen that the retention of in vivo properties is retained, or perhaps even improved with Extracts and post-temperature depression.

TABLE 7
Cleavage rates reported post thaw as indicators of blastocyst health

| | | | | % improved |
|---|---|---|---|---|
| | | | | relative to |
| Replicate | Treatment | # vitrified | % cleaved | control |
| 1 | Extract A | 25 | 78% | 8% |
| 1 | Control | 25 | 72% | |
| 1 | Not Vitrified | N/A | 71% | |
| | control | | | |
| 2 | Extract A | 13 | 92% | 100% |
| 2 | Control | 13 | 46% | |
| 2 | Not Vitrified | N/A | 92% | |
| | control | | | |

### Experiment 6: Layering Protect Shield Over Embryos on Cryotop In Vitrification Solution

Day 8 blastocyst stage embryos were vitrified using a commercially available Cryotop® system. All embryos used in this experiment were selected for excellent or good quality before beginning. Embryos were evaluated for health via IETS grading standards before being divided evenly into control and treatment groups to be loaded onto the cryotop.

Immediately prior to vitrification, embryos were coated with extract I, by dropping (Oil Layer), or by dipping the device into a 3 ml circular dish containing approximately 2 ml oil (Oil Dip) or left untreated (Control). Embryos and the cryodevice were then vitrified by plunging into liquid nitrogen (FIGS. 3 and 4). Embryos were stored in liquid nitrogen until thawing. Embryos were thawed using a commercial three step dilution protocol (CSU) then examined visually for re-expansion of blastocoel cavity, cell intactness, and lysis.

Results are shown in Table 8. These data demonstrate that more embryos were re-expanded after treatment with either oil dip or oil layering. Expansion is an indicator of embryo health and therefore embodiments of the invention provide improved post-thaw embryo health.

TABLE 8

| | # | # re- | % re-expansion | % improvement |
|---|---|---|---|---|
| | vitrified | expansion | of blastocoel | relative to control |
| Replicate 1 | | | | |
| Control | 9 | 1 | 11% | |
| Dip | 10 | 4 | 40% | 264% |
| Layer | 10 | 4 | 40% | 264% |
| Replicate 2 | | | | |
| Control | 9 | 4 | 44% | |
| Dip | 6 | 3 | 50% | 18% |

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the statements of invention.

Examples of alternative claim may include:
1. A method of reducing detrimental impacts to in vitro and in vivo derived samples from temperature depression comprising the steps of:
   providing a supplement to a medium;
   placing a specimen in said supplemented medium;
   subjecting said specimen to a temperature depression process;
   maintaining in vivo homeostasis in said specimen from before said temperature depression process to after said temperature depression process; and
   maintaining in vivo like organellular function and organization.
2. The method as described in clause 1 or any other clause wherein said specimen is chosen from cells, embryos, oocytes, tissues, collection of tissues, gametes, germ cells, cell lines, stem cells, bacterial cells, plant cells, fungal cells, and algal cells.
3. The method as described in clause 1 or any other clause wherein said specimen comprises sperm.
4. The method as described in clause 1 or any other clause wherein said temperature depression process comprises a process chosen from passive cooling, cooling, slow cooling, slow freezing, directional cooling, cryopreservation, vitrification, directional freezing, and freeze drying.
5. The method as described in clause 1 or any other clause and further comprising a step of using said specimen after said temperature depression process for a process chosen from implantation, culturing, and fertilization.
6. The method as described in clause 1 or any other clause wherein said step of maintaining said in vivo homeostasis in said specimen from before said temperature depression process to after said temperature depression process comprises a step of improving said in vivo homeostasis in said specimen from before said temperature depression process to after said temperature depression process.
7. The method as described in clause 1 or any other clause wherein said step of maintaining in vivo homeostasis in said specimen from before said temperature depression process to after said temperature depression process comprises including an appropriate level of reducing compounds in said medium to maintain physiological levels by reducing negative impacts of reactive compounds in said specimen.
8. The method as described in clause 1 or any other clause wherein said medium comprises a balance of reactive compounds to sufficiently catalyze cellular reactions in said specimen and wherein said balance of compounds do not exceed detrimental concentrations.
9. The method as described in clause 1 or any other clause wherein said medium comprises a component chosen from trace minerals, reducing agents, zinc, selenium, plant extracts, calcium, phosphorus, chromium, copper, manganese, nickel, strontium, vanadium, iron, molybdenum, zinc, tin, selenium, boron, barium, aluminum, titanium, lithium, cadmium, lead, reducing sugars, cytochrome P450, quercitin, isohamnetin I glycoside, carotenoids, flavonoids, diglycosides, monoglycosides, ellagitannins, quercetin-3-glycoside, glycosylated phenolic compounds, anthocyanin, phenolic acids, flavones, phenolic acid, edaravone, NXY-059, allopurinol, L-arginine, aminoguanidine, 7-nitroindazole, tirilazad, ARL 17477, 1400W, uric acid, resveratrol, curcumin, green tea catechins, caffeic acid, melatonin, edaravone, ebselen, cerium oxide, betulinic acid, and glucose oxidase compounds, vitamin C, carotenoids, mannitol, sorbitol, xylose, malic acid, d-Malic acid, citric acid, tartaric acid, succinic acid, protein, aspartic acid, long chain sugar components, palmitic acid, palmitoleic acid, stearic acid, oleic acid, 11-octadeconoic acid, linoleic acid, linolenic acid, nervonic acid, carotenoids, sterols, cholesterol, campesterol, stigmasterol, β-sistosterol, tocopherols, tocotrienols, phenolic compounds, amino acids, sugars, phytosterols, phytosterols, terpenoids, L-carnitine, acetyl-L-carnitine, N-acetyl-L-cysteine, and α-lipoic acid, any combination thereof.
10. The method as described in clause 1 or any other clause wherein said temperature depression process comprises a process that reduces a temperature to less than or equal to about −6° C. and further comprising a step of providing an osmotic pressure of said specimen of more than about 800 to about 10000 mOsm specific to the biochemical composition of said specimen
11. The method as described in clause 1 or any other clause wherein said cryoprotectant is chosen from glycerol, propylene glycol, propanediol, ethylene glycol, choline chloride, hydroypropyl cellulose, trehalose, sodium chloride, potassium chloride, magnesium sulphate, potassium dihydrogen phosphate, sodium bicarbonate, dimethylacetamide, dimethylforamide, L-proline water, 2-methyl-2,4-pentanediol, trimethylamine oxide, glucose, calcium lactate, sodium pyruvate, EDTA, HEPES, sucrose, DMSO, ficoll, calcium chloride, gentamicin sulphate, glucose, glutamine, human albumin solution, magnesium sulfate, sodium lactate, sodium pyruvate, 1,2-propanediol, propyl alcohol, glycerol, galactose, and any combination thereof.
12. The method as described in clause 1 or any other clause wherein said temperature depression process comprises a process that reduces a temperature to less than or equal to about −6° C. and further comprising a step of physically inhibiting ice crystal formation in said specimen with said medium in vitrification or cryopreservation.
13. The method as described in clause 1 or any other clause and further comprising a step of providing a total antioxidant reactivity (TAR) value of said medium of between about 0.2 and 1.29 μM Trolox Equivalents.
14. The method as described in clause 1 or any other clause wherein said specimen comprises an oocyte, and further comprising a step of reducing damage to said oocyte with said medium during said temperature depression process.
15. The method as described in clause 1 or any other clause wherein said step of maintaining in vivo like organellular function and 3-dimensional arrangement within a cell comprises a step chosen from allowing organellular interaction as per in vivo functionality and limiting damages from temperature depression and limiting damages from external moieties.
16. The method as described in clause 15 or any other clause wherein said step of maintaining in vivo like organellular function comprises a step chosen from limiting plasma membrane fluidity, other membrane damage, maintaining DNA integrity and composition, limiting release of calcium, limiting release of reactive compounds from organelles or cytoplasm.
17. The method as described in clause 15 or any other clause wherein said maintenance comprises a step chosen from allowing appropriate 3-dimensional reorganization of organelles; avoiding mitochondrial fission and fusion, avoiding zona hardening; and avoiding premature release of cortical granules.
18. The method as described in clause 1 or any other clause wherein said supplement to said medium comprises a lipid.
19. The method as described in clause 1 or any other clause wherein said supplement to said medium comprises a reducing agent.
20. The method as described in clause 1 or any other clause wherein said supplement to said medium comprises a cryoprotectant.
21. A method of protecting in vitro samples from temperature depression comprising the steps of:
   providing a supplemented medium;
   forming a droplet comprising a specimen and said supplemented medium;
   creating a protective layer around said droplet containing said medium and specimen; and
   subjecting said droplet with said protective layer to a temperature depression process.
22. The method as described in clause 21 or any other clause wherein said temperature depression process comprises a process chosen from passive cooling, cooling, slow cooling, slow freezing, directional cooling, cryopreservation, vitrification, directional freezing, and freeze drying.
23. The method as described in clause 21 or any other clause and further comprising a step of protecting said specimen during increase or decrease of temperature of said specimen as it transitions between unstable zone of temperature transitions.
24. The method as described in clause 21 or any other clause and further comprising a step of protecting said specimen from foreign compounds with said protective layer applied prior to temperature depression.
25. The method as described in clause 21 or any other clause wherein said protective layer comprises a physical barrier.
26. The method as described in clause 25 or any other clause wherein said foreign compounds are chosen from physical contaminants, pathogenic compounds, oxidants, bacteria, viruses, fungi, foreign bodies, inflammatory and immune response cells, and pathogens.
27. The method as described in clause 21 or any other clause and further comprising a step of providing cellular benefits to said specimen with said medium and said protective layer.
28. The method as described in clause 27 or any other clause wherein said cellular benefits are chosen from adding reducing agents, providing membrane stability, maintaining DNA quality, decreasing cellular reorganization, and decrease organellular reorganization.
29. The method as described in clause 21 or any other clause wherein said protective layer is chosen from a solution, coating, and additive.
30. The method as described in clause 21 or any other clause wherein said protective layer comprises components chosen from lipids, free fatty acids, long chain sugar components, unsaturated fatty acids, saturated fatty acids, polar lipids, sn-2 unsaturated fatty acids, palmitic acid, palmitoleic acid, palmitoeic, stearic acid, oleic acid, 11-Octadeconoic acid, linoleic acid, linolenic acid, phosphatidylcholine, phosphatidylinositol, phosphatidylserine, phosphatidic acid, diphosphatidylglycerol, phosphatidylethanolamine, diglactosidylacylglyerol, monogalactosydiaculglycerol, bees wax, honey, nervonic acid, mineral oil, liquid paraffin, polymers such as polysaccharides, suberin, melanin, lignin, cellulose, biological polymers, synthetic polymers such as polyethylene, polylactic acid, carotenoids, sterols, cholesterol, campesterol, stigmasterol and β-sistosterol, tocopherols, tocotrienols, phytochemical compounds, phenols, oxygen-substituted phenol derivatives, alkaloids, terpenes, phenolics and polyphenols, quinones, tannins, proanthocyanidins, egallic acid, norwogonin, chebulagic acid, chebulinic acid, coruagin, terchebulin, tanning, terpenoids, saponins, alkaloids, flavonoids, natural gums and resins, latex, phloretin, withaferin A, berbeine, catechols, eugenol, piperine, fructose, photoanemonin, salicylic acids, anthemic acids, capsaicin, cocaine, fabatin, allicin, ajoene, asiatocoside, lupulone, humulone, lawsone, alpinumisoflavone, glabrol, helanins, hexanal, menthol, reserpine, mescaline, opium, petalostemumol, reserpine, rhein, carvacrol, caffeic acids, thymol, totarol, turmeric oil, essential oils, extracts form the Cameroonian plant, extracts from Hypericum, propolis, flavonoids pinocembrin and galangin, spermidine, rutin, quercetin, kaempferol, quaternary ammonium and glucosinolate, aliphatic constituents, lectins, polypeptides, polyacetylenes, flavones, simple phenols, phenolic acids, plant extracts, genres Rubus, Hippophae, Capparis, Melaleuca, Daucus, and any combination thereof.
31. The method as described in clause 21 or any other clause wherein said protective layer comprises components chosen from vitamin E, about 30% or more saturated acids, unsaturated fatty acids, saturated fatty acids, polar lipids, sn2 lipids, phospholipids, palmitic acid, palmitoleic acid, C16 fatty acids, C18 fatty acids, oleic acid, phytosterols, sitosterol, carotenoids, and any combination thereof.
32. The method as described in clause 21 or any other clause wherein said temperature depression comprises vitrification.
33. The method as described in clause 32 or any other clause and further comprising the steps of:
   placing said specimen in a holding medium;
   moving said specimen from said holding medium to an equilibrium medium;
   moving said specimen from said equilibrium medium to a vitrification medium; and
   wherein said droplet comprises said specimen with said vitrification medium.
34. The method as described in clause 33 or any other clause and further comprising a step of loading said droplet onto a vitrification device and plunging said device with said droplet into liquid nitrogen.
35. The method as described in clause 34 or any other clause and further comprising a step of thawing said droplet in a warming medium.
36. The method as described in clause 35 or any other clause wherein said warming medium comprises a first warming medium, a second warming medium, and a third warming medium.
37. The method as described in clause 36 or any other clause wherein said first warming medium has an osmolality about 1000 mOsm or more.
38. The method as described in clause 37 or any other clause wherein a second warming medium is about half the osmolality of said first warming and said third warming medium is about a quarter of the osmolality of said first warming medium.
39. The method as described in clause 21 or any other clause wherein said specimen is chosen from cells, embryos, oocytes, tissues, collection of tissues, gametes, germ cells, cell lines, stem cells, bacterial cells, plant cells, fungal cells, and algal cells.
40. The method as described in clause 21 or any other clause wherein said specimen comprises sperm.
41. A method of introducing an in vitro sample to a recipient environment comprising the steps of:
   providing a specimen in a supplemented medium which has been subjected to a temperature depression process and re-warmed;
   treating a recipient environment with a solution before implantation of said specimen in said medium; and
   implanting said specimen in said medium into said recipient environment.
42. The method as described in clause 41 or any other clause wherein said specimen is chosen from cells, embryos, oocytes, tissues, collection of tissues, gametes, germ cells, cell lines, hepatocytes, stem cells, bacterial cells, plant cells, fungal cells, and algal cells.
43. The method as described in clause 41 or any other clause wherein said specimen comprises sperm.
44. The method as described in clause 41 or any other clause wherein said recipient environment comprises a uterine environment.
45. The method as described in clause 41 or any other clause wherein said recipient environment comprises an in vivo environment.
46. The method as described in clause 41 or any other clause wherein said solution comprises said supplemented medium.
47. The method as described in clause 41 or any other clause wherein said step of implanting said specimen in said supplemented medium comprises the step of implanting said specimen in said supplemented medium into said uterine environment with a placement device.
48. The method as described in clause 47 or any other clause wherein said placement device comprises a straw.
49. The method as described in clause 41 or any other clause wherein said placement device comprises a tube filled with a medium pocket, a medium with or without specimen pocket, and at least one air bubble.
50. The method as described in clause 41 or any other clause wherein said placement device comprises a tube filled with a preparation medium.
51. The method as described in clause 41 or any other clause wherein said placement device comprises a plug at the top, a first medium pocket, an air bubble, a second medium pocket, a second air bubble, a third medium pocket, and a seal or sealing device at the bottom.
52. The method as described in clause 51 or any other clause wherein said first medium pocket comprises a cryopreservation medium.
53. The method as described in clause 51 or any other clause wherein said second medium pocket comprises a cryopreservation medium with a specimen therein.
54. The method as described in clause 51 or any other clause wherein said third medium pocket comprises a different medium than the first and second medium pockets.
55. The method as described in clause 54 or any other clause wherein said third medium pocket comprises a uterine prep medium.
56. The method as described in clause 41 or any other clause wherein said medium or solution comprises a component chosen from trace minerals, reducing agents, zinc, selenium, plant extracts, calcium, phosphorus, chromium, copper, manganese, nickel, strontium, vanadium, iron, molybdenum, zinc, tin, selenium, boron, barium, aluminum, titanium, lithium, cadmium, lead, reducing sugars, cytochrome P450 and glucose oxidase compounds, vitamin C, carotenoids, mannitol, sorbitol, xylose, malic acid, d-Malic acid, citric acid, tartaric acid, succinic acid, protein, aspartic acid, long chain sugar components, palmitic acid, palmitoleic acid, stearic acid, oleic acid, 11-octadeconoic acid, linoleic acid, linolenic acid, nervonic acid, carotenoids, sterols, cholesterol, campesterol, stigmasterol, β-sistosterol, tocopherols, tocotrienols, phenolic compounds, amino acids, sugars, phytosterols, terpenoids, vitamin E, about 30% or more saturated acids, unsaturated fatty acids, saturated fatty acids, polar lipids, sn2 lipids, phospholipids, C16 fatty acids, C18 fatty acids, oleic acid, any combination thereof.
57. The method as described in clause 41 or any other clause wherein said temperature depression process comprises a process chosen from passive cooling, cooling, slow cooling, slow freezing, directional cooling, cryopreservation, vitrification, directional freezing, and freeze drying.
58. The method as described in clause 41 or any other clause wherein said specimen is chosen from intravenous, intramuscular, subdermal, spinal injections, and intrauterine placement methods.
59. A method of protecting in vitro species by regulating reducing compounds to achieve a biochemically relevant balance comprising the steps of:
   providing a specimen;
   providing a supplemented medium
   reducing reactive compounds containing nitrogen, oxygen, and sulfur in said specimen to render them non-detrimental;
   adding said medium to said specimen; and
   subjecting said specimen to a temperature depression process.
60. The method as described in clause 59 or any other clause wherein said specimen is chosen from cells, embryos, oocytes, sperm, tissues, collection of tissues, gametes, germ cells, cell lines, stem cells, bacterial cells, plant cells, fungal cells, and algal cells.
61. The method as described in clause 59 or any other clause wherein said temperature depression process comprises a process chosen from passive cooling, cooling, slow cooling, slow freezing, directional cooling, cryopreservation, vitrification, directional freezing, and freeze drying.
62. The method as described in clause 59 or any other clause and further comprising a step of using said specimen after said temperature depression process for a process chosen from implantation, culturing, and fertilization.
63. The methods as described in clause 59 or any other clause wherein said supplemented medium comprises of thiols, polyphenols, phospholipids, glycolipids, flavonoids, phenolic acids, flavones, anthocyanin, carotenoids, quercitin, isohamnetin (I) glycoside, ellagitannins, quercitin-3-glycoside, polar lipids, terpenes, kaempferol, oleanolic acid, triterpenoids, ursolic acid and fatty acids
64. A method of protecting in vitro and in vivo derived samples from temperature depression comprising the steps of:
   providing a supplemented medium;
   placing a specimen in said supplemented medium;
   subjecting said specimen to a temperature depression process; and
   providing a total antioxidant reactivity (TAR) value of said medium of between about 0.2 and 1.29 μM Trolox Equivalents.
65. The method as described in clause 63 or any other clause wherein said specimen is chosen from cells, embryos, oocytes, sperm, tissues, collection of tissues, gametes, germ cells, cell lines, stem cells, bacterial cells, plant cells, fungal cells, and algal cells.
66. The method as described in clause 63 or any other clause wherein said specimen comprises sperm.
67. The method as described in clause 63 or any other clause wherein said temperature depression process comprises a process chosen from passive cooling, cooling, slow cooling, slow freezing, directional cooling, cryopreservation, vitrification, directional freezing, and freeze drying.
68. The method as described in clause 63 or any other clause and further comprising a step of using said specimen after said temperature depression process for a process chosen from implantation, culturing, and fertilization.
69. The method as described in clause 63 or any other clause wherein said medium comprises a component chosen from trace minerals, reducing agents, zinc, selenium, plant extracts, calcium, phosphorus, chromium, copper, manganese, nickel, strontium, vanadium, iron, molybdenum, zinc, tin, selenium, boron, barium, aluminum, titanium, lithium, cadmium, lead, reducing sugars, cytochrome P450, quercitin, isohamnetin I glycoside, carotenoids, flavonoids, diglycosides, monoglycosides, ellagitannins, quercetin-3-glycoside, glycosylated phenolic compounds, anthocyanin, phenolic acids, flavones, phenolic acid, edaravone, NXY-059, allopurinol, L-arginine, aminoguanidine, 7-nitroindazole, tirilazad, ARL 17477, 1400W, uric acid, resveratrol, curcumin, green tea catechins, caffeic acid, melatonin, edaravone, ebselen, cerium oxide, betulinic acid, and glucose oxidase compounds, vitamin C, carotenoids, mannitol, sorbitol, xylose, malic acid, d-Malic acid, citric acid, tartaric acid, succinic acid, protein, aspartic acid, long chain sugar components, palmitic acid, palmitoleic acid, stearic acid, oleic acid, 11-octadeconoic acid, linoleic acid, linolenic acid, nervonic acid, sterols, cholesterol, campesterol, stigmasterol, 0-sistosterol, tocopherols, tocotrienols, phenolic compounds, amino acids, sugars, phytosterols, phytosterols, terpenoids, L-carnitine, acetyl-L-carnitine, N-acetyl-L-cysteine, and α-lipoic acid, any combination thereof.
70. A method of protecting in vitro species by regulating reducing compounds to achieve a biochemically relevant balance combing the steps of:
   obtaining a blend of supplements that achieve a biochemically appropriate increase over a control medium in reducing compounds sufficient to address a broad spectrum of reactive species within an in vitro system;
   assessing a required increase over an unamended medium;
   quantifying said blend of supplements by one or more of the following tests chosen from Total Antioxidant Reactivity (TAR value), FRAP, CUPRAC, DPPH, ORAC, dichlorodihydrofluorescein diacetate, probes such as Amplex red, NADH-assays, dihydrorhodamine 123, dihydroethidium, lucigenin, luciferin, and lucigenin based assays, coelenterazine, Mito-SOX, MitoTracker, EPR spin-trapping spectroscopy, cytochrome C reduction assay, nitroblue tetrazolium, HyPer Probe, and MitoBand, HKGreen-1.

As can be easily understood from the foregoing, the basic concepts of the present invention may be embodied in a variety of ways. It involves both vitrification techniques as well as devices to accomplish the appropriate vitrified specimen. In this application, the vitrification techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. As one example, terms of degree, terms of approximation, and/or relative terms may be used. These may include terms such as the words: substantially, about, only, and the like. These words and types of words are to be understood in a dictionary sense as terms that encompass an ample or considerable amount, quantity, size, etc. as well as terms that encompass largely but not wholly that which is specified. Further, for this application if or when used, terms of degree, terms of approximation, and/or relative terms should be understood as also encompassing more precise and even quantitative values that include various levels of precision and the possibility of claims that address a number of quantitative options and alternatives. For example, to the extent ultimately used, the existence or non-existence of a substance or condition in a particular input, output, or at a particular stage can be specified as substantially only x or substantially free of x, as a value of about x, or such other similar language. Using percentage values as one example, these types of terms should be understood as encompassing the options of percentage values that include 99.5%, 99%, 97%, 95%, 92% or even 90% of the specified value or relative condition; correspondingly for values at the other end of the spectrum (e.g., substantially free of x, these should be understood as encompassing the options of percentage values that include not more than 0.5%, 1%, 3%, 5%, 8% or even 10% of the specified value or relative condition, all whether by volume or by weight as either may be specified. In context, these should be understood by a person of ordinary skill as being disclosed and included whether in an absolute value sense or in valuing one set of or substance as compared to the value of a second set of or substance. Again, these are implicitly included in this disclosure and should (and, it is believed, would) be understood to a person of ordinary skill in this field. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of “vitrification” should be understood to encompass disclosure of the act of “vitrifying”—whether explicitly discussed or not—and, conversely, were there effectively disclosure of the act of “vitrifying”, such a disclosure should be understood to encompass disclosure of a “vitrification” and even a “means for vitrifying.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

### U.S. Patents

| Patent | Kind | | Name of Patentee or Applicant |
|---|---|---|---|
| Number | Code | Issue Date | of cited Document |
| 7,943,293 | B2 | 2011 May 17 | Cecchi |
| 8,071,280 | B2 | 2011 Dec. 6 | Cecchi |
| 8,071,281 | B2 | 2011 Dec. 6 | Cecchi |

### U.S. Patent Application Publications

| Publication | Kind | Publication | Name of Patentee or Applicant |
|---|---|---|---|
| Number | Code | Date | of cited Document |
| 20090298044 | A1 | 2009 Dec. 3 | Cecchi |
| 20110171625 | A1 | 2011 Jul. 14 | Cecchi |
| 20110171624 | A1 | 2011 Jul. 14 | Cecchi |

### Non-Patent Literature Documents

Al-Azawi, T., Tavukcuoglu, S., Khaki, A. A., & Hasani, S. A. (2013). Cryopreservation of
human oocytes, zygotes, embryos and blastocysts: A comparison study between slow freezing
and ultra rapid (vitrification) methods. Middle East Fertility Society Journal, 223-232.
Isachenko, V., Todorov, P., Seisenbayeva, A., Toishibekov, Y., Isachenko, E., Rahimi, G., . . .
Merzenich, M. (2018). Vitrification of human pronuclear oocytes by direct plunging into
cooling agent: Non sterile liquid nitrogen vs. sterile air. Cryobiology, 84-88.
Lamian, M. G., Sheehan, C. B., & Gardner, D. K. (2006). Vitrification of mouse pronuclear
oocytes with no direct liquid nitrogen contact. Reproductive BioMedicine Online, 66-69.
Mandawala, A. A., Harvey, S. C., Roy, T. K., & Fowler, K. E. (2016). Cryopreservation of
animal oocytes and embryos: Current progress and future prospects. Theriogenology, 1637-
1644.
Succo, S., Gadua, S. D., Serra, E., Zinellu, A., Carru, C., Porcu, C., . . . Leoni, G. G. (2018). A
recovery time after warming restores mitochondrial function and improves developmental
competence of vitrified ovine oocytes. Theriogenology, 18-26.
D. Barnes and G. Sato, (1980). Methods for Growth of Cultured Cells in Serum-Free
Medium. Analytical Biochemistry 102, pp. 255-270.
T. Truong and D. Gardner, Antioxidants increase blastocyst cryosurvival and viability post-
vitrification. Human Reproduction, Vol. 35, Issue 1, January 2020, pp. 12-23.
Al-Azawi, et al., Cryopreservation of human oocytes, zygotes, embryos and blastocysts: A
comparison study between slow freezing and ultra rapid (vitrifcation) method. Middle East
Fertility Society Journal (2013) 18, pp. 223-232.
Almagor, M. et al., Ratio between inner cell mass diameter and blastocyst diameter is
correlated with successful pregnancy outcomes of single blastocyst transfers. Fertility and
Sterility ® Vol. 106, No. 6, November 2016. pp. 1386-1391.
Bakhach, Joseph, The cryopreservation of composite tissues Principles and recent
advancement on cryopreservation of different type of tissues. Organogenesis 5: 3, 119-126;
July/August/September © 2009, 119-126.
Hasler, John (2001). Factors affecting frozen and fresh embryo transfer pregnancy rates in
cattle. Theriogenology, 1401-1415.
Pontes, J. H. F., Nonato-Junior, I., Sanches, B. V., Ereno-Junior, J. C., Uvo, S., Barreiros,
T. R. R., Oliveira, J. A., Hasler, J. F., Seneda, M. M. Comparison of embryo yield and pregnancy
rate between in vivo and in vitro methods in the same Nelore (Bos indicus) donor cows.
Theriogenology, 71 (2009) 690-697.
Rodrigues, M. C. C., Bonotto, A. L. M., Acosta, D. A. V, Boligon, A. A., Correa, M. N., Brauner,
C. C. (2018) Effect of oestrous synchrony between embryo donors and recipients, embryo
quality and state on the pregnancy rate in beef cattle. Reproduction of Domestic Animals, 152-
156.
De La Torre-Sanchez, Jose Fernando, Metabolic regulation of in-vitro-produced bovine
embryos. I. Effects of metabolic regulators at different glucose concentrations with embryos
produced by semen from different bulls. Reproduction, Fertility, and Development, 2006, 18,
585-596.
Succu, Sara et al., A recovery time after warming restores mitochondrial function and
improves developmental competence of vitrified ovine oocytes. Theriogenology, 110 (2018)
18-26.

Thus, the applicant(s) should be understood to have support to claim and make a statement of invention to at least: i) each of the vitrification devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A method of reducing detrimental impacts to in vitro and in vivo derived samples from temperature depression comprising the steps of:
providing a supplement to a medium;
assessing an in vivo homeostasis, in vivo organellular function, and in vivo organellular organization of a specimen;
placing said specimen in said supplemented medium creating an in vitro specimen;
subjecting said in vitro specimen to a temperature depression process;
maintaining said in vivo homeostasis in said in vitro specimen after said temperature depression process; and
maintaining in vivo like organellular function and organization in said in vitro specimen after said temperature depression process.

2. (canceled)

3. The method as described in claim 1 wherein said specimen comprises sperm.

4-5. (canceled)

6. The method as described in claim 1 wherein said step of maintaining said in vivo homeostasis in said in vitro specimen after said temperature depression process comprises a step of improving said in vivo homeostasis in said in vitro specimen after said temperature depression process.

7-8. (canceled)

9. The method as described in claim 1 wherein said medium comprises a component chosen from trace minerals, reducing agents, zinc, selenium, plant extracts, calcium, phosphorus, chromium, copper, manganese, nickel, strontium, vanadium, iron, molybdenum, zinc, tin, selenium, boron, barium, aluminum, titanium, lithium, cadmium, lead, reducing sugars, cytochrome P450, quercitin, isohamnetin I glycoside, carotenoids, flavonoids, diglycosides, monoglycosides, ellagitannins, quercetin-3-glycoside, glycosylated phenolic compounds, anthocyanin, phenolic acids, flavones, phenolic acid, edaravone, NXY-059, allopurinol, L-arginine, aminoguanidine, 7-nitroindazole, tirilazad, ARL 17477, 1400W, uric acid, resveratrol, curcumin, green tea catechins, caffeic acid, melatonin, edaravone, ebselen, cerium oxide, betulinic acid, and glucose oxidase compounds, vitamin C, carotenoids, mannitol, sorbitol, xylose, malic acid, d-Malic acid, citric acid, tartaric acid, succinic acid, protein, aspartic acid, long chain sugar components, palmitic acid, palmitoleic acid, stearic acid, oleic acid, 11-octadeconoic acid, linoleic acid, linolenic acid, nervonic acid, carotenoids, sterols, cholesterol, campesterol, stigmasterol, β-sistosterol, tocopherols, tocotrienols, phenolic compounds, amino acids, sugars, phytosterols, phytosterols, terpenoids, L-carnitine, acetyl-L-carnitine, N-acetyl-L-cysteine, and α-lipoic acid, any combination thereof.

10. The method as described in claim 1 wherein said temperature depression process comprises a process that reduces a temperature to less than or equal to about −6° C. and further comprising a step of providing an osmotic pressure of said specimen of more than about 800 to about 10000 mOsm specific to the biochemical composition of said specimen.

11. (canceled)

12. The method as described in claim 1 wherein said temperature depression process comprises a process that reduces a temperature to less than or equal to about −6° C. and further comprising a step of physically inhibiting ice crystal formation in said specimen with said medium in vitrification or cryopreservation.

13-14. (canceled)

15. The method as described in claim 1 wherein said step of maintaining in vivo like organellular function and organization comprises a step chosen from allowing organellular interaction as per in vivo functionality; limiting damages from said temperature depression process; and limiting damages from external moieties.

16-20. (canceled)

21. A method of protecting in vitro samples from temperature depression comprising the steps of:
providing a supplemented medium;
forming a droplet comprising a specimen and said supplemented medium;
creating a protective layer around said droplet containing said medium and specimen; and
subjecting said droplet with said protective layer to a temperature depression process.

22. (canceled)

23. The method as described in claim 21 and further comprising a step of protecting said specimen during increase or decrease of temperature of said specimen as it transitions between unstable zone of temperature transitions.

24. The method as described in claim 21 and further comprising a step of protecting said specimen from foreign compounds with said protective layer applied prior to temperature depression.

25. The method as described in claim 21 wherein said protective layer comprises a physical barrier.

26. The method as described in claim 25 wherein said foreign compounds are chosen from physical contaminants, pathogenic compounds, oxidants, bacteria, viruses, fungi, foreign bodies, inflammatory immune response cells, and pathogens.

27. The method as described in claim 21 and further comprising a step of providing cellular benefits to said specimen with said medium and said protective layer.

28. The method as described in claim 27 wherein said cellular benefits are chosen from adding reducing agents, providing membrane stability, maintaining DNA quality, decreasing cellular reorganization, and decrease organellular reorganization.

29. The method as described in claim 21 wherein said protective layer is chosen from a solution, coating, and additive.

30. The method as described in claim 21 wherein said protective layer comprises components chosen from lipids, free fatty acids, long chain sugar components, unsaturated fatty acids, saturated fatty acids, polar lipids, sn-2 unsaturated fatty acids, palmitic acid, palmitoleic acid, palmitoeic, stearic acid, oleic acid, 11-Octadeconoic acid, linoleic acid, linolenic acid, phosphatidylcholine, phosphatidylinositol, phosphatidylserine, phosphatidic acid, diphosphatidylglycerol, phosphatidylethanolamine, diglactosidylacylglyerol, monogalactosydiaculglycerol, bees wax, honey, nervonic acid, mineral oil, liquid paraffin, polymers such as polysaccharides, suberin, melanin, lignin, cellulose, biological polymers. Synthetic polymers such as polyethylene, polylactic acid, carotenoids, sterols, cholesterol, campesterol, stigmasterol and β-sistosterol, tocopherols, tocotrienols, phytochemical compounds, phenols, oxygen-substituted phenol derivatives, alkaloids, terpenes, phenolics and polyphenols, quinones, tannins, proanthocyanidins, egallic acid, norwogonin, chebulagic acid, chebulinic acid, coruagin, terchebulin, tanning, terpenoids, saponins, alkaloids, flavonoids, natural gums and resins, latex, phloretin, withaferin A, berbeine, catechols, eugenol, piperine, fructose, photoanemonin, salicylic acids, anthemic acids, capsaicin, cocaine, fabatin, allicin, ajoene, asiatocoside, lupulone, humulone, lawsone, alpinumisoflavone, glabrol, helanins, hexanal, menthol, reserpine, mescaline, opium, petalostemumol, reserpine, rhein, carvacrol, caffeic acids, thymol, totarol, turmeric oil, essential oils, extracts form the Cameroonian plant, extracts from Hypericum, propolis, flavonoids pinocembrin and galangin, spermidine, rutin, quercetin, kaempferol, quaternary ammonium and glucosinolate, aliphatic constituents, lectins, polypeptides, polyacetylenes, flavones, simple phenols, phenolic acids, plant extracts, genres Rubus, Hippophae, Capparis, Melaleuca, Daucus, and any combination thereof.

31. The method as described in claim 21 wherein said protective layer comprises components chosen from vitamin E, about 30% or more saturated acids, unsaturated fatty acids, saturated fatty acids, polar lipids, sn2 lipids, phospholipids, palmitic acid, palmitoleic acid, C₁₆ fatty acids, C₁₈ fatty acids, oleic acid, phytosterols, sitosterol, carotenoids, and any combination thereof.

32. The method as described in claim 21 wherein said temperature depression comprises vitrification.

33. The method as described in claim 32 and further comprising the steps of:
placing said specimen in a holding medium;
moving said specimen from said holding medium to an equilibrium medium;
moving said specimen from said equilibrium medium to a vitrification medium; and
wherein said droplet comprises said specimen with said vitrification medium.

34-36. (canceled)

37. The method as described in claim 36 wherein said first warming medium has an osmolality about 1000 mOsm or more.

38-70. (canceled)
